(19) United States
(12) Patent Application Publication
(10) Pub. No.: US 2026/0104654 A1
(43) Pub. Date: Apr. 16, 2026

(54) TRANSFER UNIT AND IMAGE FORMING APPARATUS INCLUDING THE SAME

(71) Applicant: KYOCERA Document Solutions Inc., Osaka (JP)

(72) Inventor: Masayuki YAMADA, Osaka (JP)

(73) Assignee: KYOCERA Document Solutions Inc., Osaka (JP)

(21) Appl. No.: 19/352,171

(22) Filed: Oct. 7, 2025

(30) Foreign Application Priority Data
Oct. 11, 2024 (JP) 2024-178800

(51) Int. Cl. G03G 15/01; G03G 15/16; G03G 21/16

(52) U.S. Cl. CPC G03G 15/0136; G03G 15/0189; G03G 15/1605; G03G 15/167; G03G 21/1647

(57) ABSTRACT

A transfer unit includes a switching cam and a fixed cam. The fixed cam includes a second guide hole, a positioning groove, and a cam positioning recessed portion. The second guide hole is formed to overlap a first guide hole and is engaged with a first and a second engaging portion. The positioning groove is formed in an outer peripheral part of the second guide hole along the radial direction and is engaged with, when a first roller is arranged opposite an image carrying member, the first engaging portion and, when a second roller is arranged opposite the image carrying member, the second engaging portion. The cam positioning recessed portion is formed in the outer peripheral part of the second guide hole along the radial direction and is engaged with the second engaging portion when the first engaging portion engages with the positioning groove.

### INCORPORATION BY REFERENCE

This application is based on and claims the benefit of priority from Japanese Patent Application No. 2024-178800 filed on October 11, 2024, the contents of which are hereby incorporated by reference.

### BACKGROUND

The present disclosure relates to a transfer unit that transfers to a recording medium a toner image formed on an image carrying member such as a photosensitive drum or an intermediate transfer belt and also relates to an image forming apparatus including the same. More specifically, the present disclosure relates to a mechanism that switches the arrangement of a plurality of transferring members.

Generally, known image forming apparatuses include an endless intermediate transfer belt rotated in a predetermined direction and a plurality of image forming portions provided along the intermediate transfer belt and employ an intermediate transfer method involving primary transfer in which toner images of different colors are overlayed sequentially on one another on the intermediate transfer belt by the image forming portions and secondary transfer in which the toner images are secondarily transferred to a recording medium such as a sheet by a secondary transfer roller.

In such an image forming apparatus employing the intermediate transfer method, toner keeps attaching to the surface of the secondary transfer roller during durability printing. Worth particular mentioning is that, to improve color rendering and color reproduction, calibration needs to be performed with predetermined timing to correct image density and color displacement and, during the calibration, a patch image that is formed on the intermediate transfer belt is removed by a belt cleaning device without being transferred to a sheet. Thus, when the patch image passes across the secondary transfer roller, part of the toner transferred to the intermediate transfer belt attaches to the secondary transfer roller.

The conventional method of cleaning the secondary transfer roller involves applying a reverse transfer voltage (a voltage of the same polarity as the toner) to the secondary transfer roller when no image formation is in progress to bring the toner having attached to the secondary transfer roller back to the intermediate transfer belt. Inconveniently, this method takes time to clean the secondary transfer roller, resulting in a long waiting time for printing.

To cope with this, a method has been developed aimed at improving productivity by configuring the second transfer roller switchable to a size that fits a recording medium. For example, one known image forming apparatus includes a plurality of secondary transfer rollers with different lengths from each other along an axial direction, a rotary member including a support portion that rotatably supports the plurality of secondary transfer rollers and that is rotatable about an axis parallel to the axial direction, and a control portion that selects one roller from the plurality of secondary transfer rollers according to the width of a recording medium and that rotates the support portion to bring the roller opposite the intermediate transfer belt.

On the other hand, one known transfer unit includes a first and a second roller as transfer rollers, a first and a second bearing member, a roller holder, a first and a second urging member, a switching cam, a transfer voltage power supply, and a driving mechanism. The transfer unit rotates the roller holder to arrange one of the first and second rollers opposite an image carrying member and rotates the switching cam to arrange the first or second roller arranged opposite the image carrying member selectively either at a reference position, at which it stays in pressed contact with the image carrying member to form a transfer nip portion, or at a separation position, at which it is away from the image carrying member.

However, the above configurations are not specific about the specific configuration of a separating mechanism that moves the secondary transfer roller away from the intermediate transfer belt. In addition, the above configurations entail a risk of causing damage to the secondary transfer roller or the intermediate transfer belt when the secondary transfer roller is switched or replaced. Also, there is room for improvement in terms of the position accuracy of the transfer roller and the smoothness of its switching when the transfer roller is switched from a movement state to a pressing state.

An object of the present disclosure is to provide a transfer unit that, when one of two transfer rollers selectively kept in pressed contact with an image carrying member is switched to the other, can improve the position accuracy of the roller and the smoothness of its switching, and to provide an image forming apparatus including such a transfer unit.

### SUMMARY

In order to attain the above object, according to a first configuration of the present disclosure, a transfer unit includes a transfer roller that has a core metal and an elastic layer laid on the outer circumferential surface of the core metal and that is kept in pressed contact with an image carrying member to form a transfer nip portion. The transfer unit transfers a toner image formed on the image carrying member to a recording medium passing through the transfer nip portion. The transfer unit includes a transfer roller including a first and a second roller, a first and a second bearing member, a roller holder, a first and a second urging member, a switching cam, a driving mechanism, a unit frame, and a fixed cam. The second roller is disposed above the first roller and is different from the first roller. The first bearing member rotatably supports the first roller. The second bearing member rotatably supports the second roller. The roller holder includes a first and a second bearing holding portion that hold the first and second bearing members respectively such that the first and second bearing members are slidable in directions toward and away from the image carrying member. The first urging member is disposed between the first bearing holding portion and the first bearing member and urges the first bearing member in a direction toward the image carrying member. The second urging member is disposed between the second bearing holding portion and the second bearing member and urges the second bearing member in a direction toward the image carrying member. The switching cam has a first guide hole with which a first and a second engaging portion that are formed in the first and second bearing members, respectively, engage. The driving mechanism drives the roller holder and the switching cam to rotate. The unit frame rotatably supports the roller holder and the switching cam. The fixed cam is fixed to the unit frame. The roller holder is rotated such that either the first or second roller is arranged opposite the image carrying member and the switching cam is rotated to change the engagement position of the first or second engaging portion with the first guide hole to thereby arrange the first or second roller arranged opposite the image carrying member selectively between a reference position where the first or second roller is kept in pressed contact with the image carrying member to form the transfer nip portion and a separation position where the first or second roller is kept away from the image carrying member. The fixed cam includes a second guide hole, a positioning groove, and a cam positioning recessed portion. The second guide hole is formed so as to overlap the first guide hole and is engaged with the first and second engaging portions. The positioning groove is formed in an outer peripheral part of the second guide hole along a radial direction and is engaged with, when the first roller is arranged opposite the image carrying member, the first engaging portion and, when the second roller is arranged opposite the image carrying member, the second engaging portion. The cam positioning recessed portion is formed in an outer peripheral part of the second guide hole along the radial direction and is engaged with the second engaging portion when the first engaging portion engages with the positioning groove.

Other objects of the present disclosure and specific advantages obtained from the present disclosure will become apparent from the description of the embodiment given below.

### BRIEF DESCRIPTION OF THE DRAWINGS

FIG. 1 is a schematic diagram showing the inner configuration of an image forming apparatus 100 including a secondary transfer unit 9 of the present disclosure.

FIG. 2 is an enlarged view around an image forming portion Pa in FIG. 1.

FIG. 3 is a side sectional view of an intermediate transfer unit 30 incorporated in the image forming apparatus 100.

FIG. 4 is a perspective view of the secondary transfer unit 9 according to one embodiment of the present disclosure incorporated in the image forming apparatus 100.

FIG. 5 is an enlarged perspective view showing the configuration of a roller holder 47 in the secondary transfer unit 9 according to the embodiment.

FIG. 6 is a perspective view around the roller holder 47 in the secondary transfer unit 9 as seen from inward along the axial direction.

FIG. 7 is a perspective view showing a driving mechanism for the secondary transfer unit 9 according to the embodiment.

FIG. 8 is a block diagram showing one example of control paths in the image forming apparatus 100 incorporating the secondary transfer unit 9 according to the embodiment.

FIG. 9 is a side sectional view around a switching cam 50 in the secondary transfer unit 9 according to the embodiment, showing a state where a first roller 40 is placed in a reference position to form a secondary transfer nip portion N as seen from inward along the axial direction.

FIG. 10 is a diagram showing a state where, as compared with the state in FIG. 9, the switching cam 50 is removed to expose a fixed cam 52.

FIG. 11 is a diagram showing a separation state of the first roller 40, where, as compared with the state in FIG. 9, the switching cam 50 has been rotated counterclockwise through a predetermined angle.

FIG. 12 is a diagram showing a state where, as compared with the state in FIG. 11, the switching cam 50 has been rotated further counterclockwise through a predetermined angle to arrange a second roller 41 opposite a drive roller 10.

FIG. 13 is a diagram showing a state where, as compared with the state in FIG. 12, the switching cam 50 has been rotated clockwise through a predetermined angle to arrange the second roller 41 in the reference position to form the secondary transfer nip portion N.

FIG. 14 is a diagram showing a separation state of the second roller 41, where, as compared with the state in FIG. 13, the switching cam 50 has been rotated further counterclockwise through a predetermined angle.

FIG. 15 is a side view showing a state where a core metal 40a of the first roller 40 arranged in the reference position to form the secondary transfer nip portion N is fitted in a shaft holding portion 37 of the intermediate transfer unit 30.

FIG. 16 is a side view showing a state where a first engaging portion 43a of a first bearing member 43 is not engaged with a positioning groove 66 in the fixed cam 52 and the core metal 40a of the first roller 40 is out of the shaft holding portion 37.

FIG. 17 is a perspective view of the fixed cam 52 used in the secondary transfer unit 9 according to the embodiment, as seen from its side facing the roller holder 47.

FIG. 18 is a perspective view of the roller holder 47 used in the secondary transfer unit 9 according to the embodiment, as seen from its side facing the fixed cam 52.

FIG. 19 is a perspective view of a holder positioning projected portion 67 of the fixed cam 52 engaged with a holder positioning depressed portion 68 of the roller holder 47, as seen from inward along the axial direction.

### DETAILED DESCRIPTION

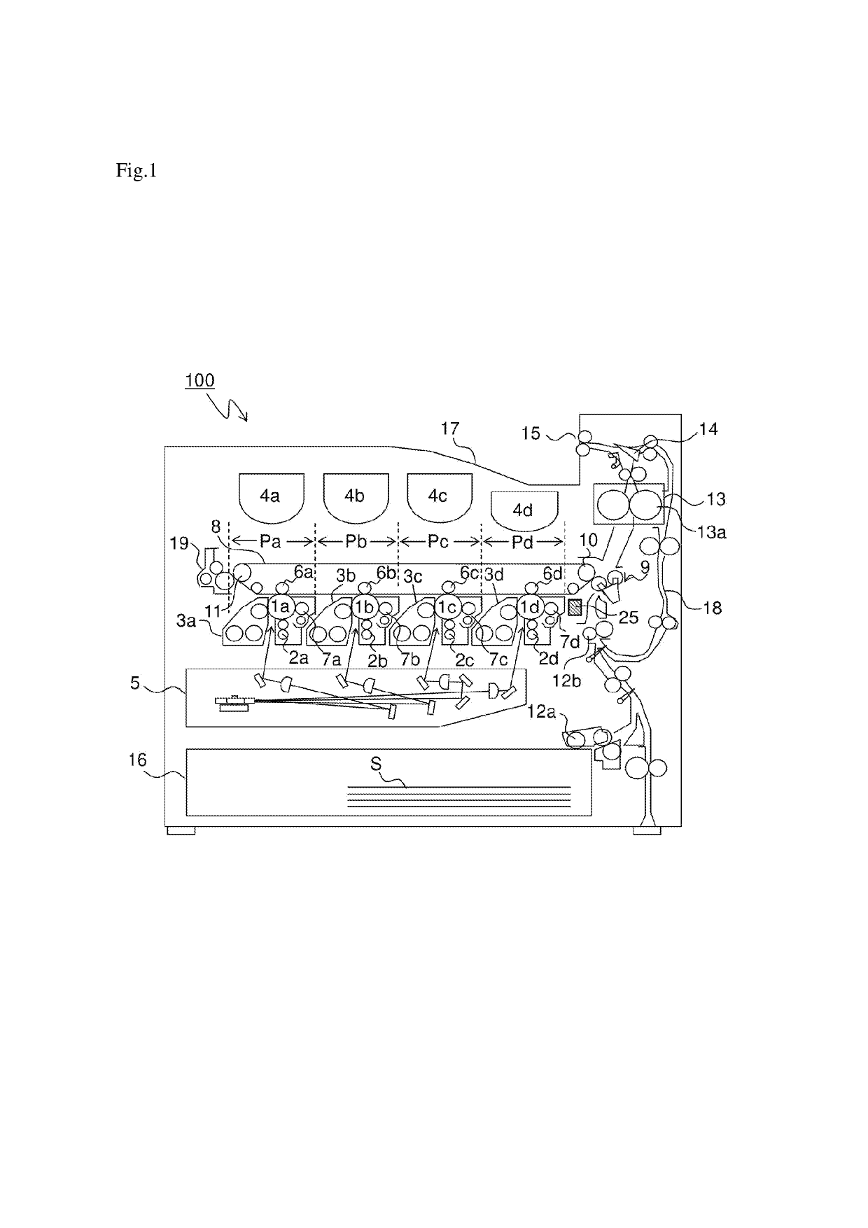

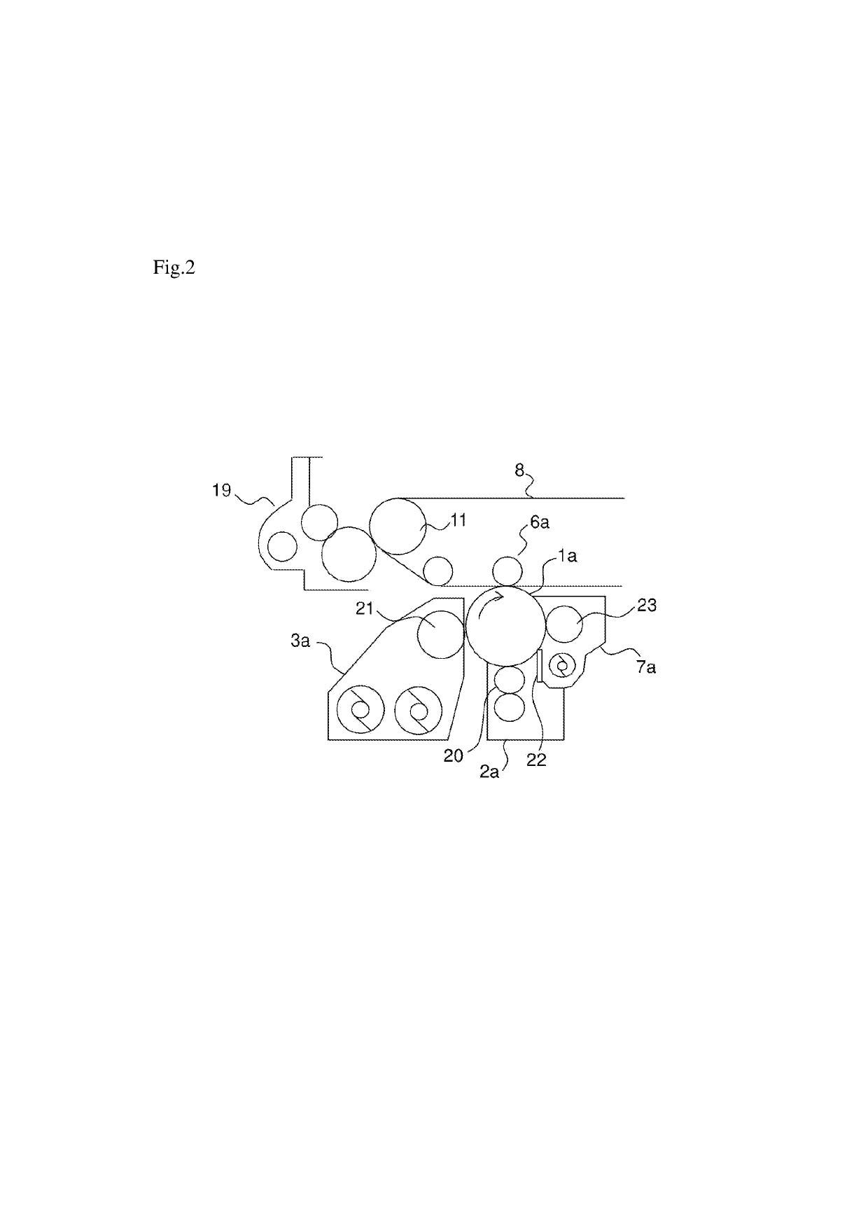

An embodiment of the present disclosure will be described below with reference to the drawings. FIG. 1 is a schematic diagram showing the configuration of an image forming apparatus 100 including a secondary transfer unit 9 of the present disclosure. FIG. 2 is an enlarged view around an image forming portion Pa in FIG. 1.

The image forming apparatus 100 shown in FIG. 1 is what is called a tandem-type color printer and is configured as follows. In the body of the image forming apparatus 100, four image forming portions Pa, Pb, Pc, and Pd are disposed in this order from upstream (left side in FIG. 1) in the conveyance direction. These image forming portions Pa to Pd are provided so as to correspond to images of four different colors (magenta, cyan, yellow, and black) and sequentially form a magenta, a cyan, a yellow, and a black image, respectively, each through the processes of electrostatic charging, exposure to light, image development, and image transfer.

These image forming portions Pa to Pd are provided with photosensitive drums 1a, 1b, 1c, and 1d that carry visible images (toner images) of the different colors. An intermediate transfer belt 8 that rotates counterclockwise in FIG. 1 is also provided adjacent to the image forming portions Pa to Pd. Toner images formed on these photosensitive drums 1a to 1d are sequentially transferred to the intermediate transfer belt 8 that moves while in contact with the photosensitive drums 1a to 1d, and are then transferred at once to a sheet S as one example of a recording medium by the secondary transfer unit 9. The toner images are then fixed to the sheet S in a fixing portion 13 and the sheet S is discharged out of the body of the image forming apparatus 100. With the photosensitive drums 1a to 1d rotated clockwise in FIG. 1, an image formation process is performed with respect to each of the photosensitive drums 1a to 1d.

The sheet S, to which the toner images are to be transferred, is stored in a sheet storage cassette 16 provided in a lower part of the body of the image forming apparatus 100 and is conveyed via a sheet feed roller 12a and a pair of registration rollers 12b to the secondary transfer unit 9. Typically used as the intermediate transfer belt 8 is a belt without a seam (a seamless belt).

Next, the image forming portions Pa to Pd will be described. The image forming portion Pa will be described in detail below and, since the image forming portions Pb to Pd share the basic configuration with the image forming portion Pa, no overlapping description will be repeated. As shown in FIG. 2, around the photosensitive drum 1a, along the rotation direction of the drum (clockwise in FIG. 2), a charging device 2a, a development device 3a, and a cleaning device 7a are disposed with a primary transfer roller 6a provided across the intermediate transfer belt 8. Upstream of the photosensitive drum 1a in the rotation direction of the intermediate transfer belt 8, a belt cleaning unit 19 is disposed opposite a tension roller 11 across the intermediate transfer belt 8.

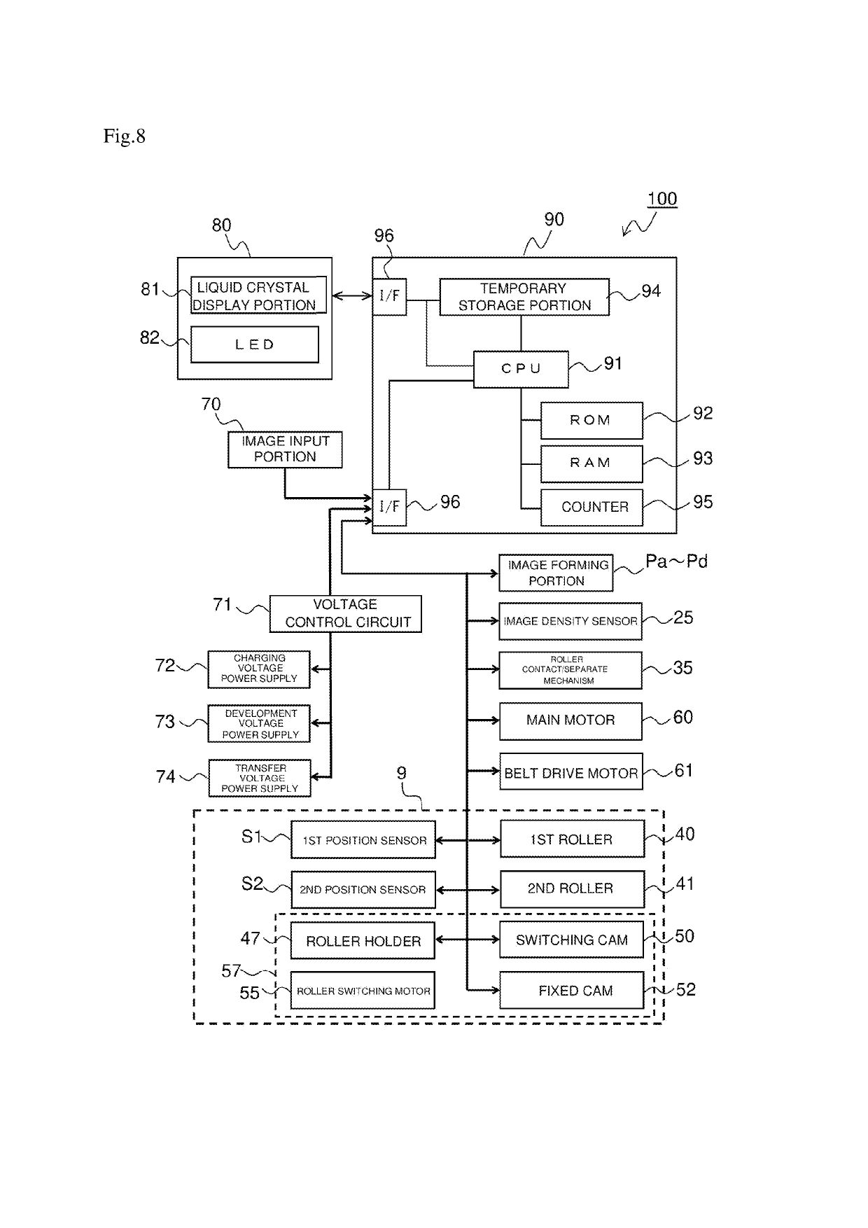

Next, an image formation procedure performed on the image forming apparatus 100 will be described. When a user inputs an instruction to start image formation, first the photosensitive drums 1a to 1d start to be rotated by a main motor 60 (see FIG. 8) and the surfaces of the photosensitive drums 1a to 1d are electrostatically charged evenly by a charging roller 20 in the charging devices 2a to 2d. Then, the surfaces of the photosensitive drums 1a to 1d are irradiated with a beam of light (laser light) emitted from an exposure device 5 to form on the photosensitive drums 1a to 1d electrostatic latent images corresponding to an image signal.

The development devices 3a to 3d are loaded with predetermined amounts of toner of different colors, namely magenta, cyan, yellow, and black, respectively. Note that, when as toner images are formed as will be described later the proportion of toner in two-component developer loaded in the development devices 3a to 3d falls below a prescribed value, toner is supplied from toner containers 4a to 4d to the development devices 3a to 3d. The toner in the two-component developer is fed to the photosensitive drums 1a to 1d by a development roller 21 in the development devices 3a to 3d and electrostatically attaches to them. This forms toner images corresponding to the electrostatic latent images formed by exposure to light emitted from the exposure device 5.

Then the primary transfer rollers 6a to 6d produce electric fields with a predetermined transfer voltage between the primary transfer rollers 6a to 6d and the photosensitive drums 1a to 1d so as to primarily transfer the magenta, cyan, yellow, and black toner image on the photosensitive drums 1a to 1d to the intermediate transfer belt 8. These images of four colors are formed in a predetermined positional relationship determined in advance so as to form a predetermined full-color image. Then, the toner left on the surfaces of the photosensitive drums 1a to 1d is removed by a cleaning blade 22 and a rubbing roller 23 in the cleaning devices 7a to 7d in preparation for the subsequent formation of new electrostatic latent images.

When as a belt drive motor 61 (see FIG. 8) rotates a drive roller 10 the intermediate transfer belt 8 starts to rotate counterclockwise, a sheet S is conveyed with predetermined timing from the pair of registration rollers 12b to a secondary transfer unit 9 provided adjacent to the intermediate transfer belt 8, and the full-color image is transferred to it. The sheet S having the toner images transferred to it is conveyed to the fixing portion 13. The toner left on the surface of the intermediate transfer belt 8 is removed by the belt cleaning unit 19.

The sheet S conveyed to the fixing portion 13 is heated and pressed by a pair of fixing rollers 13a to fix the toner images to the surface of the sheet S to form the predetermined full-color image. The sheet S having the full-color image formed on it has its conveyance direction switched by a branch portion 14 branching into a plurality of directions and is discharged as it is (or after being conveyed to a reversing conveyance passage 18 and having images formed on both sides) to a discharge tray 17 by a pair of discharging rollers 15.

Downstream of the image forming portion Pd, at a position facing the intermediate transfer belt 8, an image density sensor 25 is disposed. Typically used as the image density sensor 25 is an optical sensor including a light-emitting element comprising an LED or the like and a light-receiving element comprising a photo diode or the like. When, for measurement of the amount of toner attached to the intermediate transfer belt 8, measurement light is emitted from the light-emitting element to patch images (reference images) formed on the intermediate transfer belt 8, and the measurement light enters the light-receiving element as light reflected from toner and as light reflected from the belt surface.

The light reflected from the toner and the belt surface includes regularly reflected light and irregularly reflected light. The regularly and irregularly reflected light are split by a polarizing beam splitter prism and enter separate light-receiving elements, respectively. The light-receiving elements perform photoelectric conversion on the received regularly and irregularly reflected light and feed output signals to a control portion 90 (see FIG. 8).

Based on the change of the characteristics of the output signals for regularly and irregularly reflected light, the image density (the amount of toner) and the image position of a patch image are sensed and they are compared with a reference density and a reference position determined in advance to adjust the characteristic value of the development voltage, the position and timing that the exposure device 5 starts exposure, and the like. In this way, for each color, image density and color displacement are corrected (i.e., calibrated).

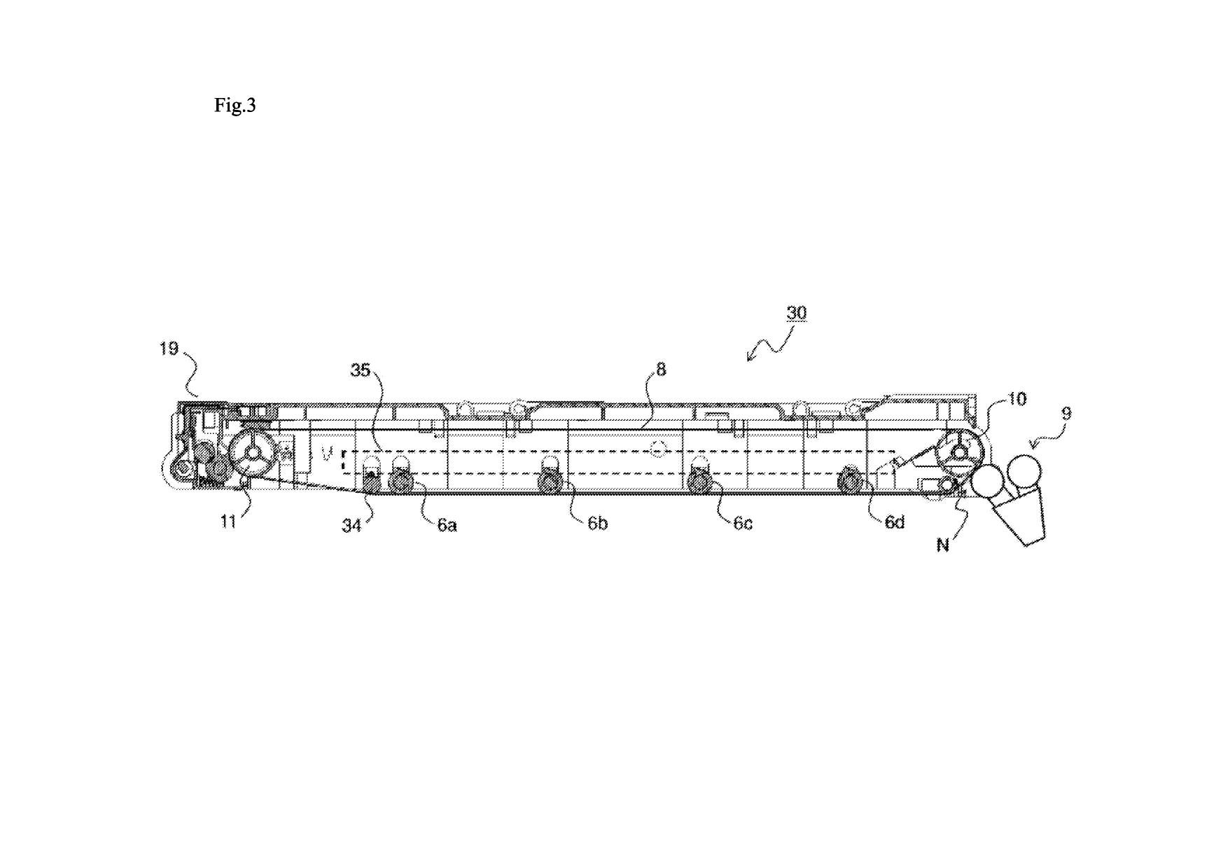

FIG. 3 is a side sectional view of an intermediate transfer unit 30 incorporated in the image forming apparatus 100. As shown in FIG. 3, the intermediate transfer unit 30 includes the intermediate transfer belt 8 wound around the drive roller 10 at the downstream side and the tension roller 11 at the upstream side, the primary transfer rollers 6a to 6d in contact with the photosensitive drums 1a to 1d across the intermediate transfer belt 8, and a pressure switching roller 34.

At a position facing the tension roller 11, the belt cleaning unit 19 is disposed for removing the toner left on the surface of the intermediate transfer belt 8. Opposite the drive roller 10 across the intermediate transfer belt 8, the secondary transfer unit 9 is disposed and these form a secondary transfer nip portion N. The configuration of the secondary transfer unit 9 will be described in detail later.

The intermediate transfer unit 30 includes a roller contact/separate mechanism 35 that includes: a pair of support members (not shown) that supports the primary transfer rollers 6a to 6d and the pressure switching roller 34 at both ends of their rotation shafts such that they are rotatable and movable perpendicularly (i.e., in the top-bottom direction in FIG. 3) to the movement direction of the intermediate transfer belt 8; and a driving means (not shown) that moves the primary transfer rollers 6a to 6d and the pressure switching roller 34 such that they reciprocate in the top-bottom direction. The roller contact/separate mechanism 35 can be switch among; a color mode in which the four primary transfer rollers 6a to 6d are all kept in pressed contact with the photosensitive drums 1a to 1d (see FIG. 1) across the intermediate transfer belt 8; a monochrome mode in which the primary transfer roller 6d alone is kept in pressed contact with the photosensitive drum 1d across the intermediate transfer belt 8; and a retracted mode in which the four primary transfer rollers 6a to 6d are all away from the photosensitive drums 1a to 1d.

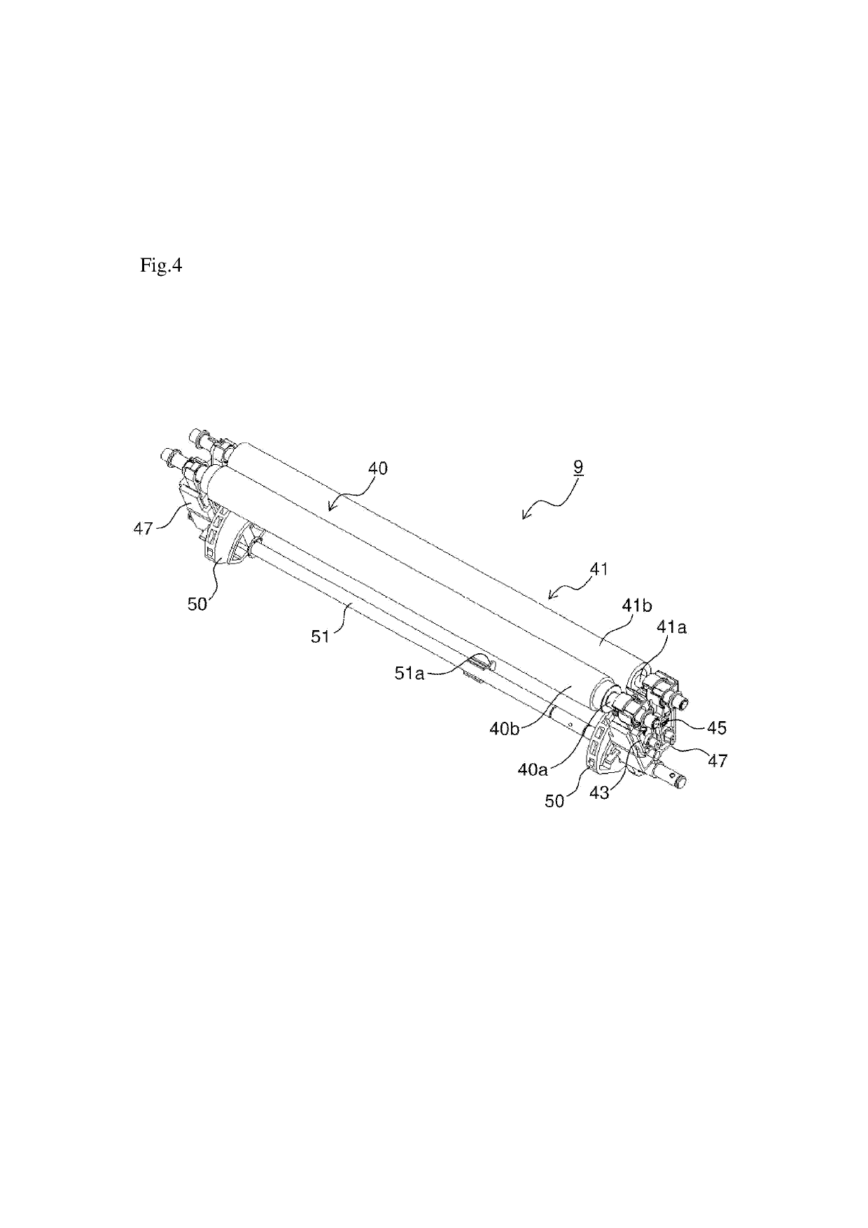

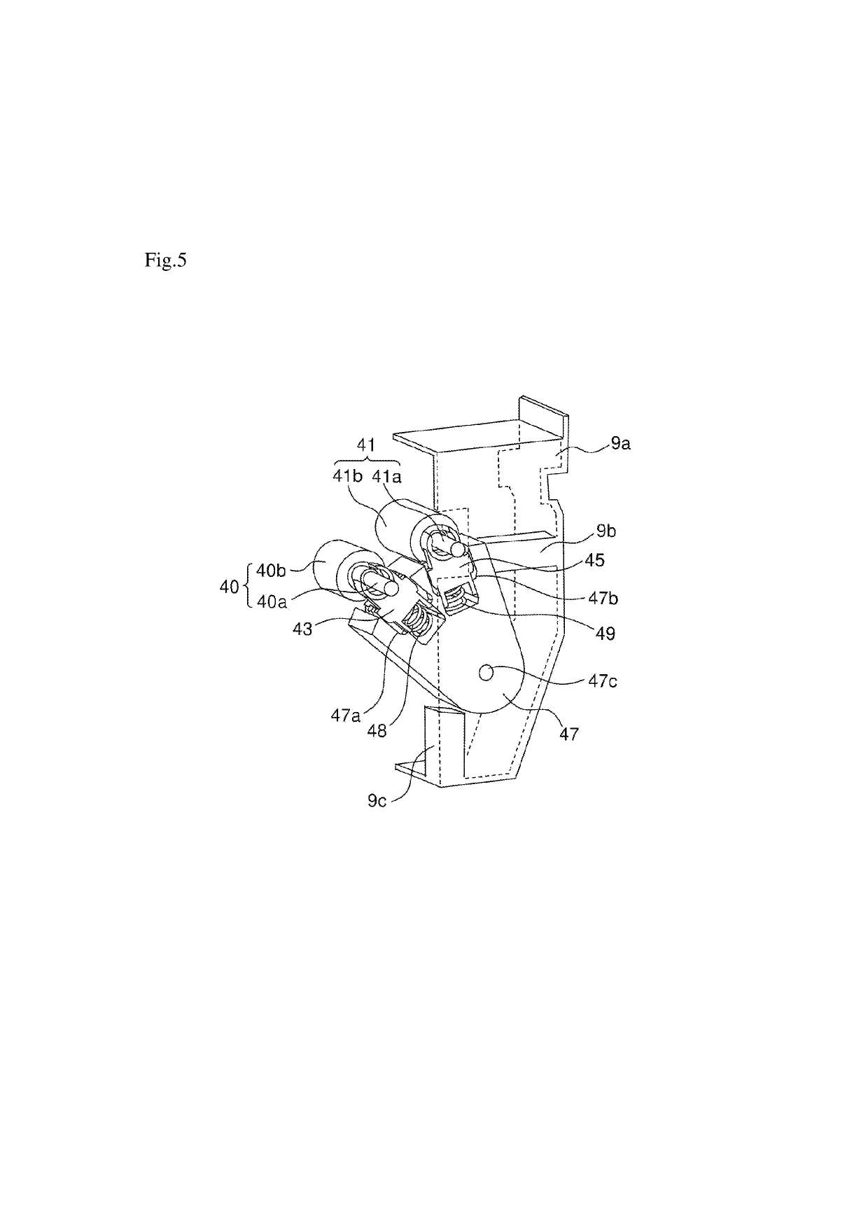

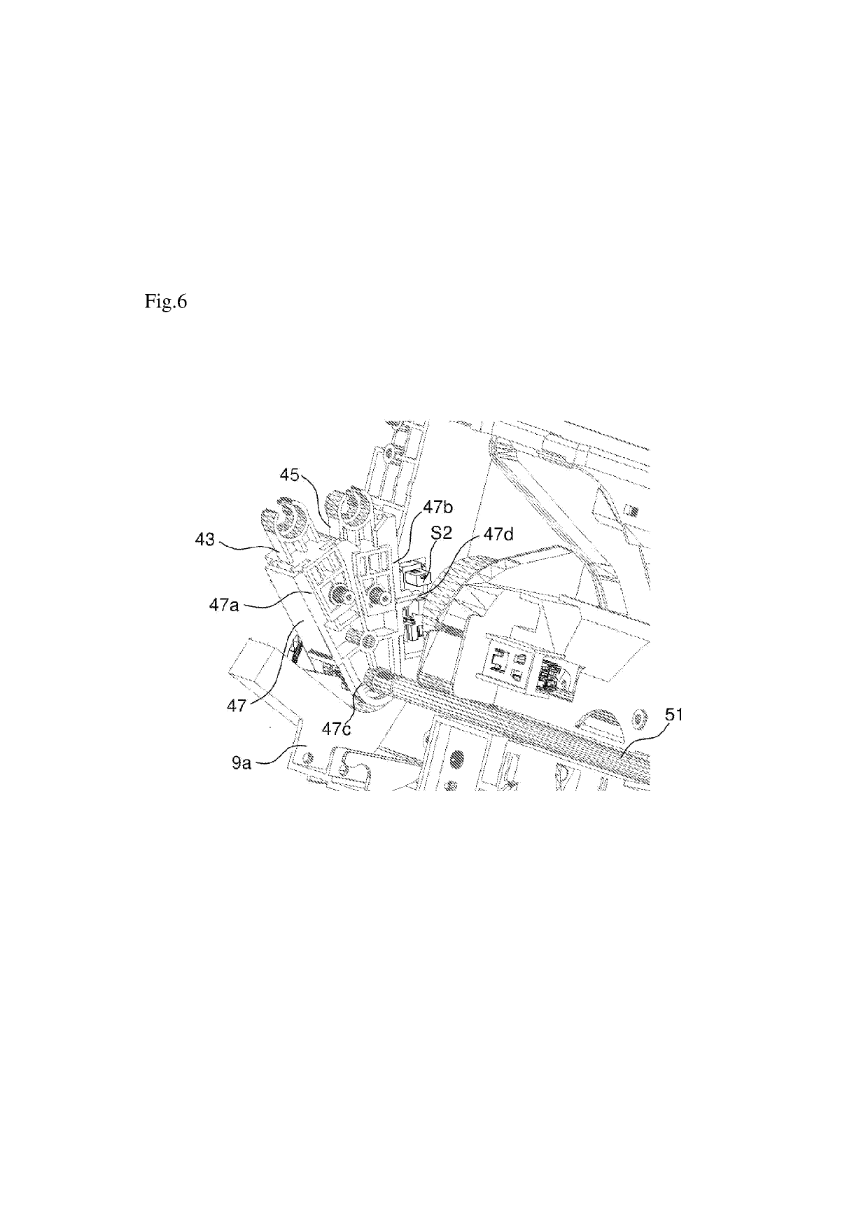

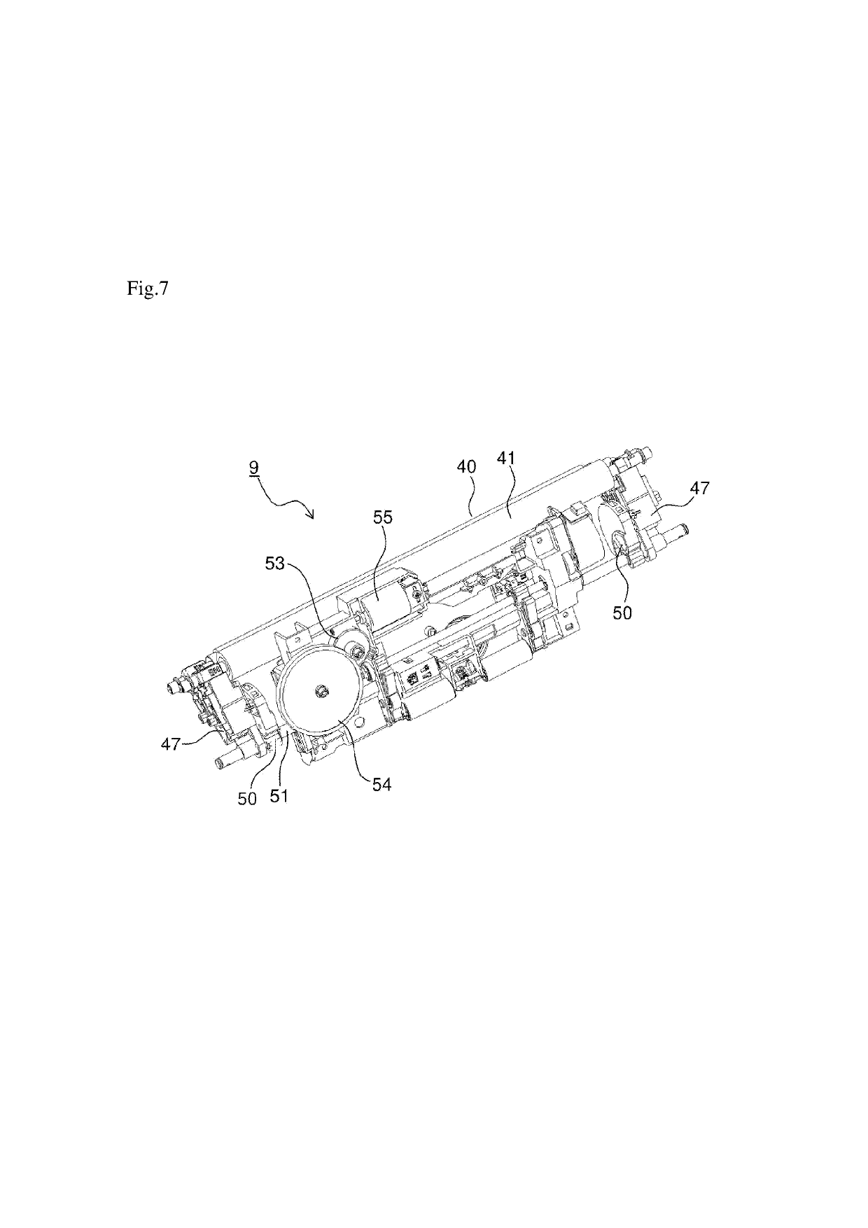

FIG. 4 is a perspective view of the secondary transfer unit 9 according to one embodiment of the present disclosure incorporated in the image forming apparatus 100. FIG. 5 is an enlarged perspective view showing the configuration of the secondary transfer unit 9 at its one side according to the embodiment. FIG. 6 is a perspective view around a roller holder 47 in the secondary transfer unit 9 as seen from inward along the axial direction. FIG. 7 is a perspective view showing a driving mechanism for the secondary transfer unit 9 according to the embodiment. Note that in FIGS. 4 and 7 a unit frame 9a is omitted from illustration and in FIG. 5 the unit frame 9a is shown as transparent. Likewise, in FIGS. 5 and 6 a switching cam 50 and a fixed cam 52 are omitted from illustration and in FIGS. 4 and 7 the fixed cam 52 is omitted from illustration.

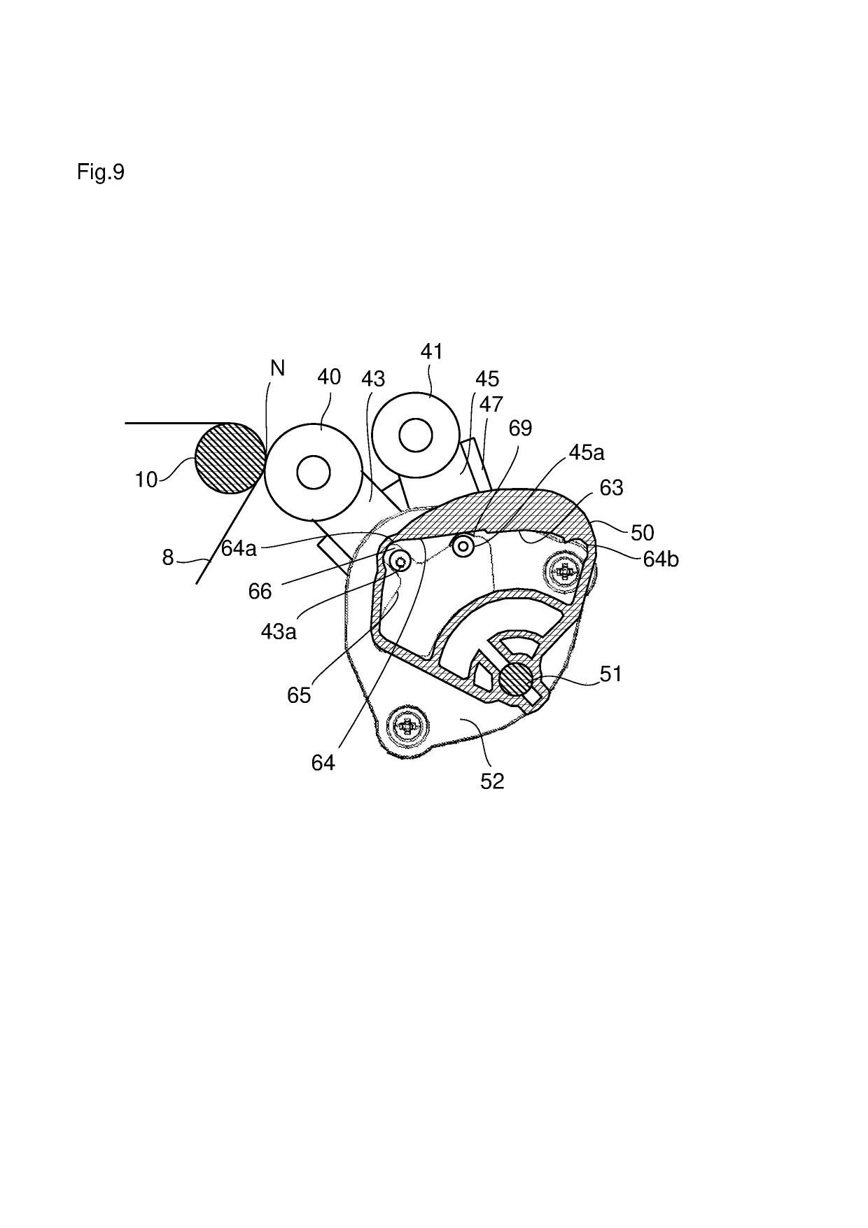

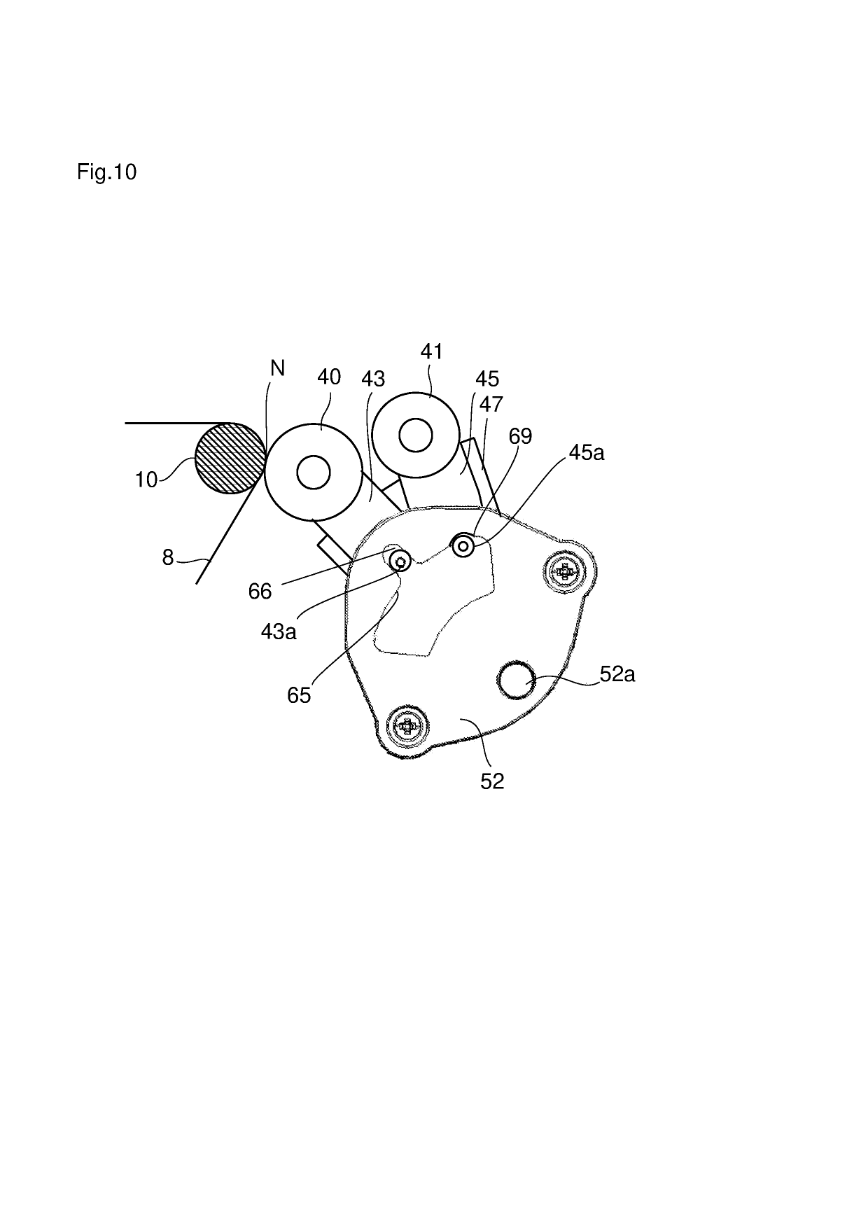

As shown in FIGS. 4 to 7, the secondary transfer unit 9 includes a first and a second roller 40 and 41 as secondary transfer rollers, a first and a second bearing member 43 and 45, a roller holder 47, a switching cam 50, a fixed cam 52 (see FIGS. 9 and 10), and a roller switching motor 55.

The first and second rollers 40 and 41 are elastic rollers having conductive elastic layers 40b and 41b laid on the outer circumferential surfaces of core metals 40a and 41a, respectively. Used as the material of the elastic layers 40b and 41b is ion conductive rubber such as ECO (epichlorohydrin rubber).

The elastic layer 40b of the first roller 40 has a length of 311 mm along the axial direction and thus fits an A3-sized sheet. The elastic layer 41b of the second roller 41 has a greater length along the axial direction than the elastic layer 40b of the first roller 40. More specifically, the elastic layer 41b has a length of 325 mm along the axial direction and thus fits a 13 inch-sized sheet.

The first bearing member 43 is disposed one at each of both ends of the first roller 40 along the axial direction and rotatably supports the core metal 40a. The second bearing member 45 is disposed one at each of both ends the second roller 41 along the axial direction of and supports the core metal 41a.

The roller holder 47 is disposed one at each of both ends of the first and second rollers 40 and 41 along the axial direction. The roller holder 47 is formed substantially in a V shape as seen from the side face and includes a first and a second bearing holding portion 47a and 47b and a through hole 47c. The first and second bearing holding portions 47a and 47b slidably hold the first and second bearing members 43 and 45 respectively. The through hole 47c is formed in a vertex part of a V shape and a shaft 51 is rotatably inserted through it. The roller holder 47 is formed of an insulating material such as synthetic resin.

As shown in FIG. 5, between the first bearing holding portion 47a and the first bearing member 43, a first coil spring (a first urging member) 48 is disposed. Between the second bearing holding portion 47b and the second bearing member 45, a second coil spring (a second urging member) 49 is disposed. The first and second rollers 40 and 41 are urged by the first and second coil springs 48 and 49, respectively, both in a direction away from the shaft 51 (in a direction in which they are brought into pressed contact with the drive roller 10).

As shown in FIG. 4, the shaft 51 is fitted with a first light-blocking plate 51a, which blocks light to a sensing portion of a first position sensor S1 (see FIG. 8), to permit the sensing of the rotation angle of the shaft 51. Likewise, as shown in FIG. 6, on one side face of the roller holder 47 along its rotation direction a second light-blocking plate 47d is formed. The second light-blocking plate 47d is formed at a position where it can block light to a sensing portion of a second position sensor S2 disposed on the unit frame 9a.

The first and second light-blocking plates 51a and 47d turning on and off the first and second position sensors S1 and S2 based on the rotation angle of the roller holder 47 (and the shaft 51) permits the sensing of the positions of the first and second rollers 40 and 41 supported on the roller holder 47. The control for the sensing of the positions of the first and second rollers 40 and 41 will be described later.

The switching cam 50 is disposed one at each of both ends of the first and second rollers 40 and 41 along the axial direction, inward of the roller holder 47. The switching cam 50 is in the shape of a fan part of which is cut out as seen in a side view and is at a pivot part of it (a vertex part at which two radii intersect) of the fan shape is fixed at the shaft 51.

As shown in FIG. 7, the shaft 51 has a roller switching motor 55 coupled to it via gears 53 and 54. The switching cam 50 is rotated together with the shaft 51 to switch the arrangement of the first and second rollers 40 and 41, and vice versa. The control for the switching of the first and second rollers 40 and 41 will be described later.

FIG. 8 is a block diagram showing one example of the control paths in the image forming apparatus 100 incorporating the secondary transfer unit 9 according to the embodiment. While the entire image forming apparatus 100 has complex control paths since its use involves various kinds of control for different parts, the following description will focus on those control paths that are necessary to implement the present disclosure.

The control portion 90 at least includes a CPU (central processing unit) 91 as a central arithmetic processor, a ROM (read only memory) 92 as a read-only memory, a RAM (random-access memory) 93 as a rewritable memory, a temporary storage portion 94 that temporarily stores image data and the like, a counter 95, a plurality of (here, two) I/Fs (interfaces) 96 that transmit control signals to different devices in the image forming apparatus 100 and receive input signals from an operation unit 80. The control portion 90 can be provided anywhere in the body of the image forming apparatus 100.

The ROM 92 stores data and the like that are not changed during the use of the image forming apparatus 100, such as programs for controlling the image forming apparatus 100 and values necessary for the control. The RAM 93 stores necessary data produced during the control of the image forming apparatus 100, temporarily necessary data for the control of the image forming apparatus 100, and the like. The RAM 93 (or the ROM 92) also stores a density correction table used in calibration, the relationship between the on/off states of the first and second position sensors S1 and S2 used in roller switching control, which will be described later, and the rotation angles of the first and second rollers 40 and 41. The counter 95 cumulatively counts the number of sheets printed.

The control portion 90 transmits control signals from the CPU 91 via the I/Fs 96 to different portions and devices in the image forming apparatus 100. From the different portions and devices, signals indicating their states as well as input signals are transmitted via the I/Fs 96 to the CPU 91. Examples of the different portions and devices controlled by the control portion 90 include the image forming portions Pa to Pd, the exposure device 5, the primary transfer rollers 6a to 6d, the secondary transfer unit 9, the roller contact/separate mechanism 35, the main motor 60, the belt drive motor 61, an image input portion 70, a voltage control circuit 71, and the operation unit 80.

The image input portion 70 is a receiving portion that receives image data fed from a host device such as a personal computer to the image forming apparatus 100. An image signal fed in through the image input portion 70 is converted into a digital signal and is then transmitted to the temporary storage portion 94.

The voltage control circuit 71 is connected to a charging voltage power supply 72, a development voltage power supply 73, and a transfer voltage power supply 74 and operates these power supplies according to an output signal from the control portion 90. With the control signal from the voltage control circuit 71, these power supplies apply predetermined voltages as follows: the charging voltage power supply 72, to the charging roller 20 in the charging devices 2a to 2d; the development voltage power supply 73, to the development roller 21 in the development devices 3a to 3d; the transfer voltage power supply 74, to the primary transfer rollers 6a to 6d and to the first and second rollers 40 and 41 in the secondary transfer unit 9.

The operation unit 80 is provided with a liquid crystal display portion 81 and LEDs 82 indicating various states; a user’s press on a stop/clear button on the operation unit 80 cancels image formation and a user’s press on a reset button sets the various settings for the image forming apparatus 100 to the default settings. The liquid crystal display portion 81 displays the status of the image forming apparatus 100, the progress of image formation, and the number of copies printed. Various settings for the image forming apparatus 100 are made via a printer driver on the personal computer.

FIG. 9 is a side sectional view around the switching cam 50 in the secondary transfer unit 9 according to the embodiment, showing a state where the first roller 40 is placed at a position where it forms the secondary transfer nip portion N as seen from inward along the axial direction. FIG. 10 is a diagram showing a state where, as compared with the state in FIG. 9, the switching cam 50 is removed to expose the fixed cam 52.

As shown in FIG. 9, the switching cam 50 is in the shape of a fan as seen in a plan view. The switching cam 50 has a first guide hole 63 in the shape of an arc. The first guide hole 63 is engaged with a first and a second engaging portion 43a and 45a formed in the first and second bearing members 43 and 45 respectively.

The first guide hole 63 has a recessed portion 64 and an engaging recessed portion 64b. The recessed portion 64 is formed with an outer peripheral part of the first guide hole 63 along the radial direction recessed further outward along the radial direction and it stretches from the middle, along the circumferential direction, of the outer peripheral part of the first guide hole 63 along the radial direction to one side (left side in FIG. 9) along the circumferential direction.

In the embodiment, the recessed portion 64 is formed in a V shape on a sectional plane perpendicular to the axial direction. A bottom part 64a of the recessed portion 64 is bent in the shape of a semi-arc. As the switching cam 50 rotates, the first and second engaging portions 43a and 45a are arranged in or away from the recessed portion 64. This allows the switching of the contact state of the first and second rollers 40 and 41 with the intermediate transfer belt 8. Note that the control for the switching of and position sensing for the first and second rollers 40 and 41 will be described in detail later.

The engaging recessed portion 64b is formed with, in an end part of the first guide hole 63 at the other side (right side in FIG. 9) along the circumferential direction, an outer peripheral part of the first guide hole 63 along the radial direction is recessed further outward along the radial direction. The engaging recessed portion 64b is engaged with the second engaging portion 45a.

The fixed cam 52 is provided between the roller holder 47 and the switching cam 50. The fixed cam 52 is fixed with a screw to the unit frame 9a in the secondary transfer unit 9 (see FIG. 10).

The fixed cam 52 has a through hole 52a, a second guide hole 65 in the shape of an arc, a positioning groove 66, and a cam positioning recessed portion 69. Through the through hole 52a, the shaft 51 is rotatable inserted.

The second guide hole 65 is formed at a position overlapping the first guide hole 63 of the switching cam 50 and is engaged with the first and second engaging portions 43a and 45a.

The positioning groove 66 is, when the first roller 40 is arranged opposite the drive roller 10, engaged with the first engaging portion 43a and, when the second roller 41 is arranged opposite the drive roller 10, engaged with the second engaging portion 45a.

In the embodiment, the positioning groove 66 is formed in an outer peripheral part of the second guide hole 65 along the radial direction so as to be recessed from its middle along the circumferential direction outward along the radial direction. In addition, the dimension of the positioning groove 66 (the width of the groove) along the circumferential direction is slightly larger than the outer diameters of the first and second engaging portion 43a and 45a.

The cam positioning recessed portion 69 is formed in an outer peripheral part of the second guide hole 65 along the radial direction and is arranged adjacent to the positioning groove 66 along the circumferential direction. The cam positioning recessed portion 69 is, when the first engaging portion 43a is engaged with the positioning groove 66, engaged with the second engaging portion 45a.

In the embodiment, the cam positioning recessed portion 69 is formed in an outer peripheral part of the second guide hole 65 along the radial direction so as to be recessed from an end part of it at the other side (right side in FIG. 10) along the circumferential direction outward along the radial direction. In addition, the cam positioning recessed portion 69 is formed less recessed along the radial direction than the positioning groove 66 and the dimension (width) of the cam positioning recessed portion 69 along the circumferential direction is slightly larger than the outer diameter of the second engaging portion 45a.

FIG. 9 shows a state where the first engaging portion 43a of the first bearing member 43 is engaged with the bottom part 64a of the recessed portion 64. This brings the first roller 40 into pressed contact with the drive roller 10 via the intermediate transfer belt 8 under the urging force of the first coil spring 48 (see FIG. 5) to form the secondary transfer nip portion N. Thus, the first roller 40 rotates by following the drive roller 10. To the first roller 40, a transfer voltage with the opposite polarity (here, the negative polarity) to the toner is applied by the transfer voltage power supply 74 (see FIG. 8). Specifically, when the first roller 40 is arranged in the position in FIG. 9, the transfer voltage is applied to it via the first bearing member 43 electrically connected to the transfer voltage power supply 74.

The first light-blocking plate 51a (see FIG. 4) on the shaft 51 blocks light to (i.e., turns on) the sensing portion of the first position sensor S1 and the second light-blocking plate 47d (see FIG. 6) on the roller holder 47 blocks light to (i.e., turns on) the sensing portion of the second position sensor S2. This state (where S1 and S2 are on) is defined as a reference position (home position) of the first roller 40. The rotation angle of the switching cam 50 is regulated based on the time for which the switching cam 50 rotates from this reference position to control the first roller 40 between an arranged and a separated state.

When the first engaging portion 43a is engaged with the positioning groove 66 in the fixed cam 52, the second engaging portion 45a is engaged with the cam positioning recessed portion 69. This prevents the first roller 40 from being displaced along the circumferential direction due to the rotation of the switching cam, improving the position accuracy with which the first roller 40 is arranged in a reference position.

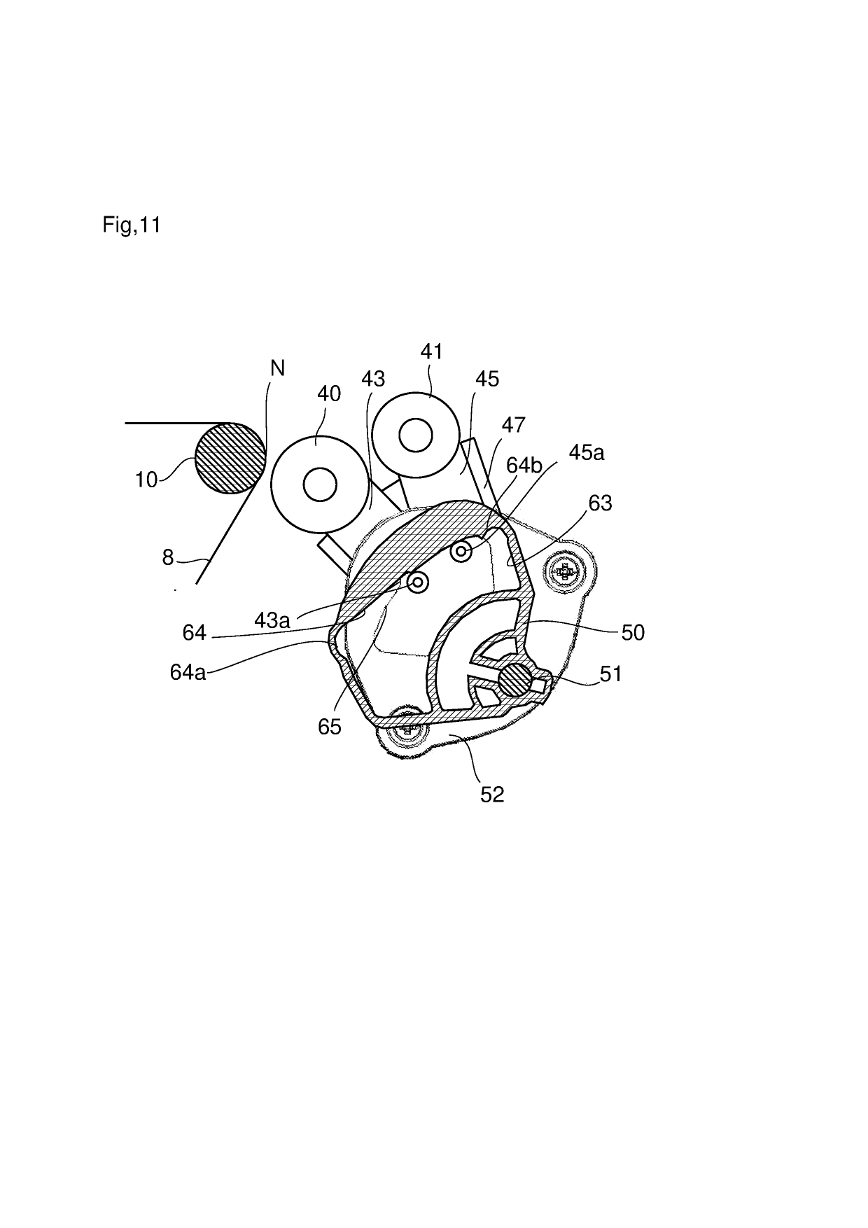

Next, with reference to FIGS. 11 to 15 as well as FIGS. 4 to 10 as necessary, the control for the switching of and sensing of the positions of the first and second rollers 40 and 41 in the secondary transfer unit 9 according to the embodiment will be described.

FIG. 11 is a diagram showing a state where, as compared with the state in FIG. 9, the switching cam 50 has been rotated counterclockwise through a predetermined angle. As the shaft 51 rotates counterclockwise, together with the shaft 51, the switching cam 50 rotates. Meanwhile, the first engaging portion 43a moves from the bottom part 64a of the recessed portion 64 across a sloped face of the recessed portion 64. At the same time, the first bearing member 43 moves within the positioning groove 66 toward the shaft 51 against the urging force of the first coil spring 48 (see FIG. 5). As the first engaging portion 43a moves out of the recessed portion 64, it is disengaged from the positioning groove 66. This is the state (separation state) where the first roller 40 is away from the intermediate transfer belt 8.

On the other hand, the second engaging portion 45a moves, as the switching cam 50 rotates, across a sloped face of the recessed portion 64. At the same time, the second bearing member 45 moves within the cam positioning recessed portion 69 toward the shaft 51 against the urging force of the second coil spring 49 (see FIG. 5). As the second engaging portion 45a moves out of the recessed portion 64, it is disengaged from the cam positioning recessed portion 69. This disengages the roller holder 47 from the fixed cam 52.

If the first roller 40 is left in pressed contact with the drive roller 10 for a long time, the first roller 40 may be bent and deformed along the axial direction. To avoid that, the first roller 40 needs to be moved away from the intermediate transfer belt 8 (drive roller 10) after a job is complete. This brings the separation state shown in FIG. 11.

Here, the first light-blocking plate 51a on the shaft 51 is retracted from (i.e., turns off) the sensing portion of the first position sensor S1, and the second light-blocking plate 47d on the roller holder 47 keeps blocking light to (i.e., keeps on) the sensing portion of the second position sensor S2. That is, the transition from the sensing state in FIG. 9 (where S1 and S2 are on) to the sensing state in FIG. 11 (where S1 is off and S2 is on) permits the sensing of the movement of the first roller 40 from the reference position to the separation position.

To move the first roller 40 from the separation state back to the reference position, the roller holder 47 and the switching cam 50 are rotated clockwise. At this time, the roller holder 47 is prevented from clockwise rotation by a restricting rib 9b (see FIG. 5). As a result, the first and second engaging portions 43a and 45a move into the recessed portion 64 to be engaged with the positioning groove 66 and the cam positioning recessed portion 69, respectively.

Next, a description will be given of a procedure for switching the roller that forms the secondary transfer nip portion N from the first roller 40 to the second roller 41. As the shaft 51 is rotated counterclockwise from the separation state shown in FIG. 11, together with the shaft 51, the switching cam 50 rotates counterclockwise. At that time, the first bearing member 43 is urged in a direction away from the shaft 51 under the urging force of the first coil spring 48 (see FIG. 5). Likewise, the second bearing member 45 is urged in a direction away from the shaft 51 under the urging force of the second coil spring 49 (see FIG. 5). This brings the first and second engaging portions 43a and 45a into pressed contact with the outer peripheral part of the first guide hole 63 in the switching cam 50 along the radial direction. Thus, together with the switching cam 50, the roller holder 47 rotates counterclockwise.

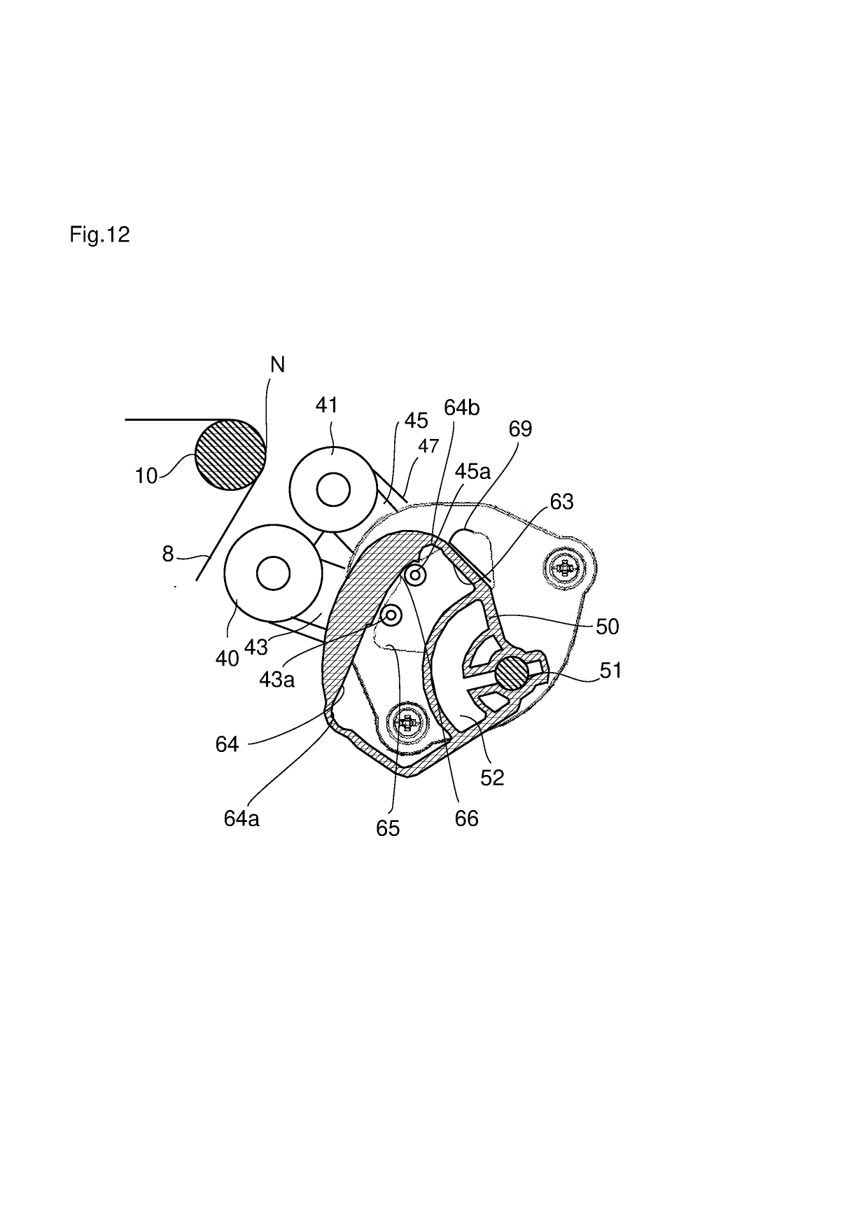

When the roller holder 47 rotates until it makes contact with a restricting rib 9c (see FIG. 5), the second roller 41 is arranged at a position opposite the drive roller 10 as shown in FIG. 12. Now, part of the second engaging portion 45a enters an opening end of the positioning groove 66. In the state shown in FIG. 12, the first light-blocking plate 51a on the shaft 51 is retracted from (i.e., keeps off) the sensing portion of the first position sensor S1 and the second light-blocking plate 47d on the roller holder 47 is also retracted from (i.e., keeps off) the sensing portion of the second position sensor S2. That is, the transition from the sensing state in FIG. 11 (where S1 is off and S2 is on) to the sensing state in FIG. 12 (where S1 and S2 are off) permits the sensing of the movement of the second roller 41 to the position opposite the drive roller 10.

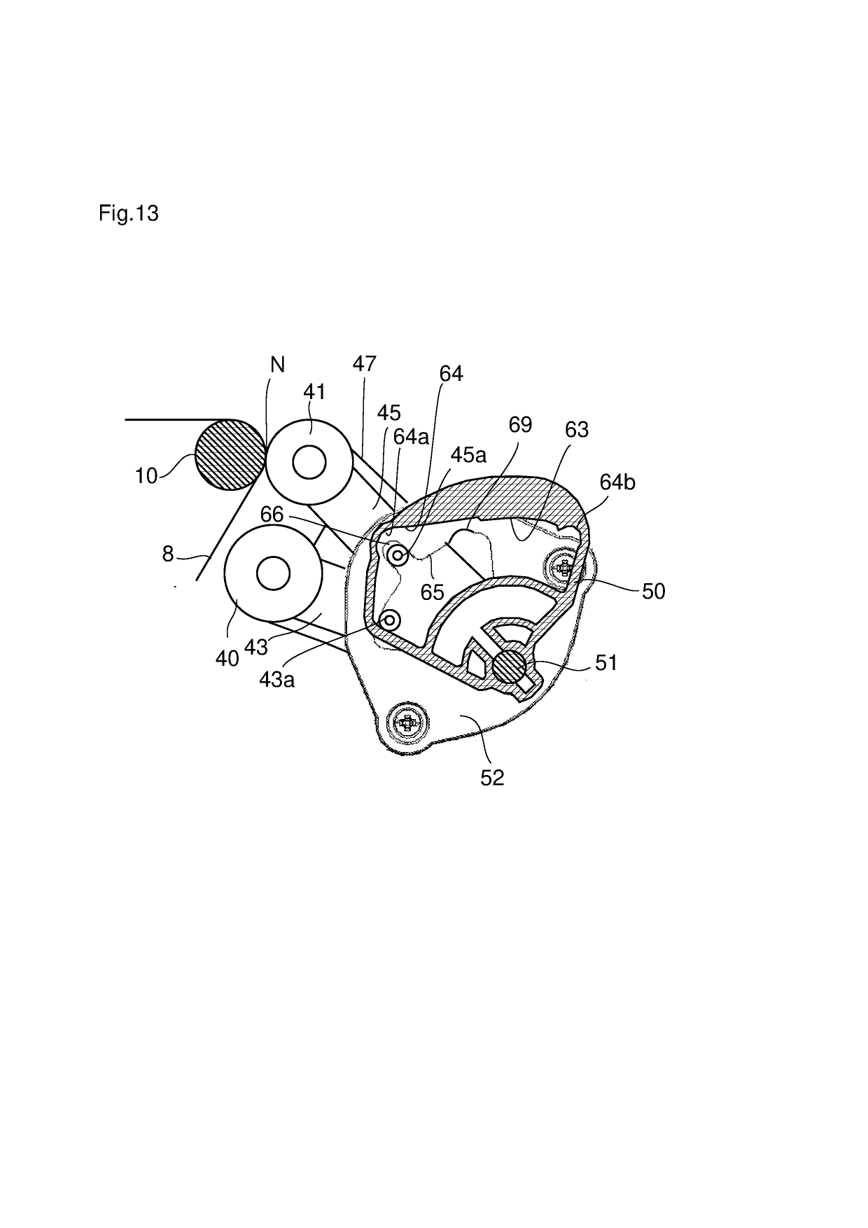

FIG. 13 is a diagram showing a state where, as compared with the state in FIG. 12, the switching cam 50 has been rotated clockwise through a predetermined angle. As the shaft 51 is rotated clockwise, together with the shaft 51, the switching cam 50 rotates. On the other hand, with part of the second engaging portion 45a having entered the opening end of the positioning groove 66 and been engaged with it, the roller holder 47 is prevented from clockwise rotation. Accordingly, the switching cam 50 alone rotates clockwise. The second bearing member 45 is acted on by a force in a direction away from the shaft 51 under the urging force of the second coil spring 49 (see FIG. 5). Thus, the second engaging portion 45a, while sliding across the outer peripheral part of the first guide hole 63 along the radial direction, gradually moves further into the positioning groove 66.

When the second engaging portion 45a reaches the bottom part 64a of the recessed portion 64, the second roller 41 is in pressed contact with the drive roller 10 via the intermediate transfer belt 8 under the urging force of the second coil spring 49 (see FIG. 5) to form the secondary transfer nip portion N. Thus, the second roller 41 rotates by following the drive roller 10. To the second roller 41, a transfer voltage with the opposite polarity (here, the negative polarity) to the toner is applied by the transfer voltage power supply 74 (see FIG. 8). Specifically, when the second roller 41 is arranged in the position in FIG. 13, the transfer voltage is applied to it via the second bearing member 45 electrically connected to the transfer voltage power supply 74.

The first light-blocking plate 51a on the shaft 51 blocks light to (i.e., keeps on) the sensing portion of the first position sensor S1 and the second light-blocking plate 47d on the roller holder 47 is retracted from (i.e., keeps off) the sensing portion of the second position sensor S2. This state (where S1 is on and S2 is off) is defined as a reference position (home position) of the second roller 41. That is, the transition from the sensing state in FIG. 12 (where S1 and S2 are off) to the sensing state in FIG. 13 (where S1 is on and S2 is off) permits the sensing of the movement of the second roller 41 to the reference position. The rotation angle of the switching cam 50 is regulated based on the time for which the switching cam 50 rotates from this reference position to control the second roller 41 between an arranged and a separated state.

If the second roller 41 is left in pressed contact with the drive roller 10 for a long time, the second roller 41 may be bent and deformed along the axial direction. To avoid that, the second roller 41 needs to be moved away from the intermediate transfer belt 8 (drive roller 10) after a job is complete. To achieve that, the shaft 51 is rotated counterclockwise and this brings the separation state shown in FIG. 12.

When calibration is performed during the use of the second roller 41, the second roller 41 needs to be in the separation state so as not to make contact with a reference image formed on the intermediate transfer belt 8. Note that, when calibration is performed with the second roller 41 in the separation state, a reference image can be formed in a middle part of the intermediate transfer belt 8 along the width direction.

Here, the first light-blocking plate 51a on the shaft 51 is retracted from (i.e., keeps off) the sensing portion of the first position sensor S1, and the second light-blocking plate 47d on the roller holder 47 keeps being retracted from (i.e., keeps off) the sensing portion of the second position sensor S2. That is, the transition from the sensing state in FIG. 13 (where S1 is on and S2 is off) to the sensing state in FIG. 12 (where S1 and S2 are off) permits the sensing of the movement of the second roller 41 from the reference position to the separation position.

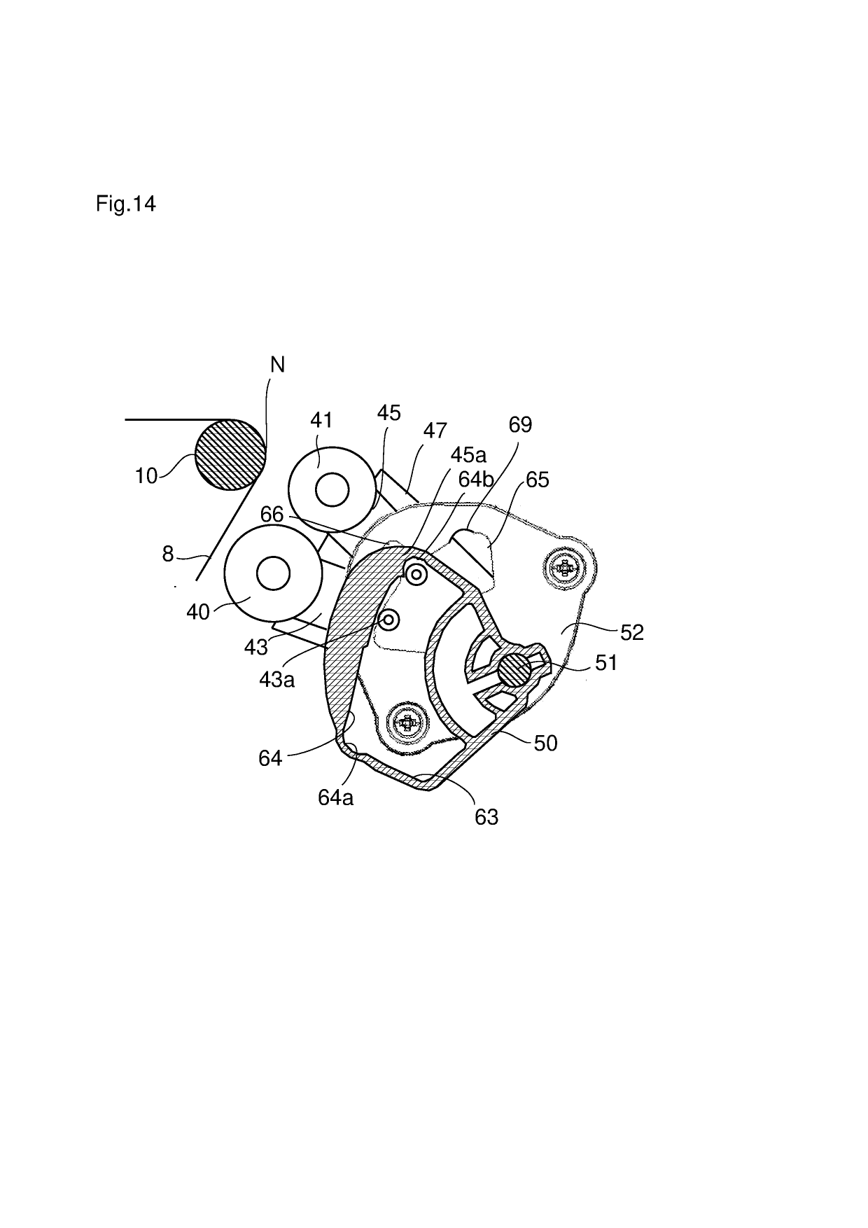

Next, a description will be given of a procedure for switching the roller that forms the secondary transfer nip portion N from the second roller 41 to the first roller 40. FIG. 14 is a diagram showing a state where, as compared with the state in FIG. 13, the switching cam 50 has been rotated counterclockwise through a predetermined angle. As the shaft 51 is rotated counterclockwise, together with the shaft 51, the switching cam 50 rotates counterclockwise. On the other hand, the roller holder 47 is prevented from counterclockwise rotation by the restricting rib 9c (see FIG. 5). As a result, the second engaging portion 45a moves from the bottom part 64a of the recessed portion 64 to an edge of the first guide hole 63 at the other side (right side in FIG. 13) along the circumferential direction to engage with the engaging recessed portion 64b.

At that time, the first engaging portion 43a has moved out of the recessed portion 64 and has been disengaged from the positioning groove 66. Likewise, the second engaging portion 45a has moved out of the recessed portion 64 and has been disengaged from the cam positioning recessed portion 69.

Next, as the shaft 51 is rotated clockwise, together with the shaft 51, the switching cam 50 rotates clockwise. Meanwhile, the second engaging portion 45a is engaged with the engaging recessed portion 64b and thus the roller holder 47, too, rotates clockwise through a predetermined angle. As the shaft 51 is rotated further clockwise, the roller holder 47 makes contact with the restricting rib 9b (see FIG. 5) to be prevented from clockwise rotation. As a result, the first and second engaging portions 43a and 45a move into the recessed portion 64 to engage with the positioning groove 66 and the cam positioning recessed portion 69, respectively. This brings the state shown in FIG. 9, where the first roller 40 is arranged in the reference position. After that, repeating the above procedure achieves the switching of the first and second rollers 40 and 41.

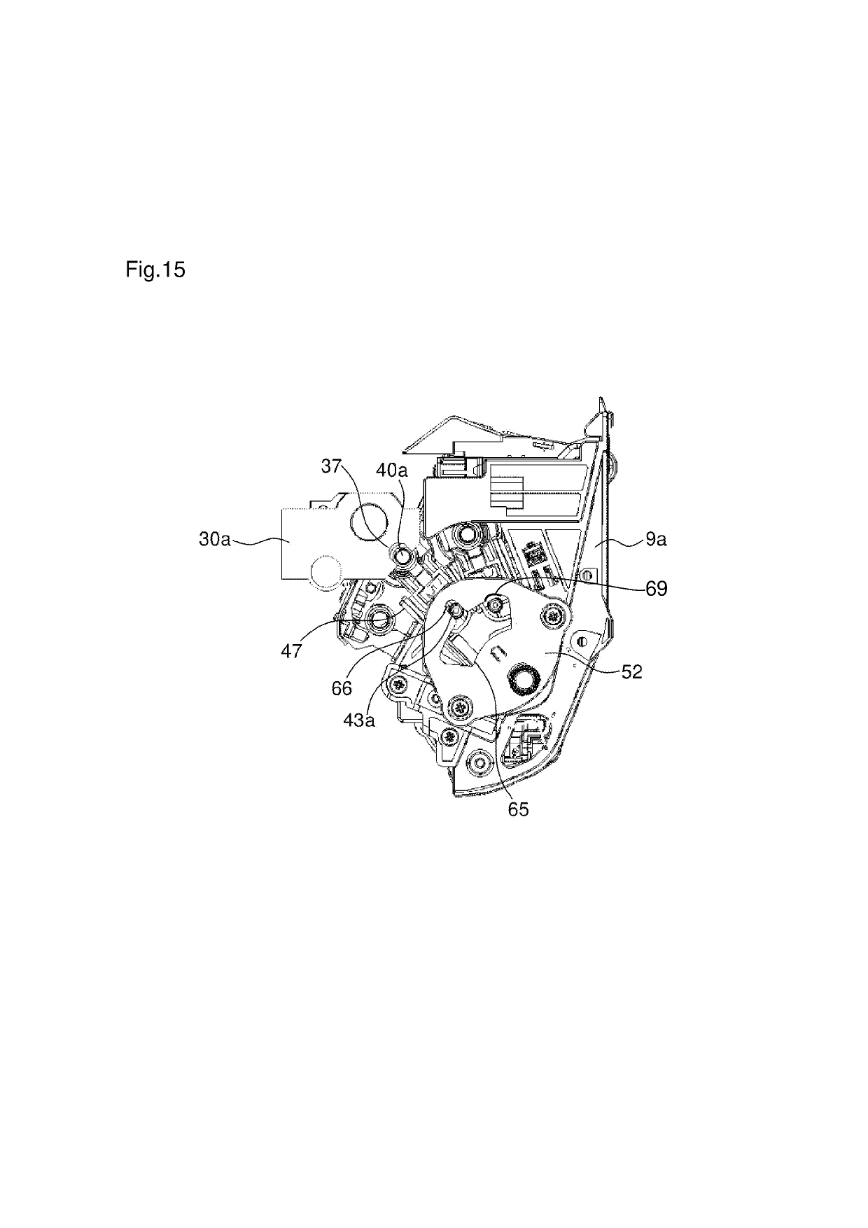

FIG. 15 is a side view showing a state where the core metal 40a of the first roller 40 arranged in the reference position to form the secondary transfer nip portion N is fitted in a shaft holding portion 37 of the intermediate transfer unit 30. A pair of side frames 30a that supports both end parts of the drive roller 10 and of the primary transfer rollers 6a to 6d in the intermediate transfer unit 30 has a shaft holding portion 37 formed in each of them. Note that FIG. 15 depicts only one each of the side frames 30a and the shaft holding portions 37.

The shaft holding portions 37 hold both end parts of the core metal 40a of the first roller 40 or both end parts of the core metal 41a of the second roller 41 arranged in the reference position. This allows accurate positioning of the first or second roller 40 or 41 in the reference position.

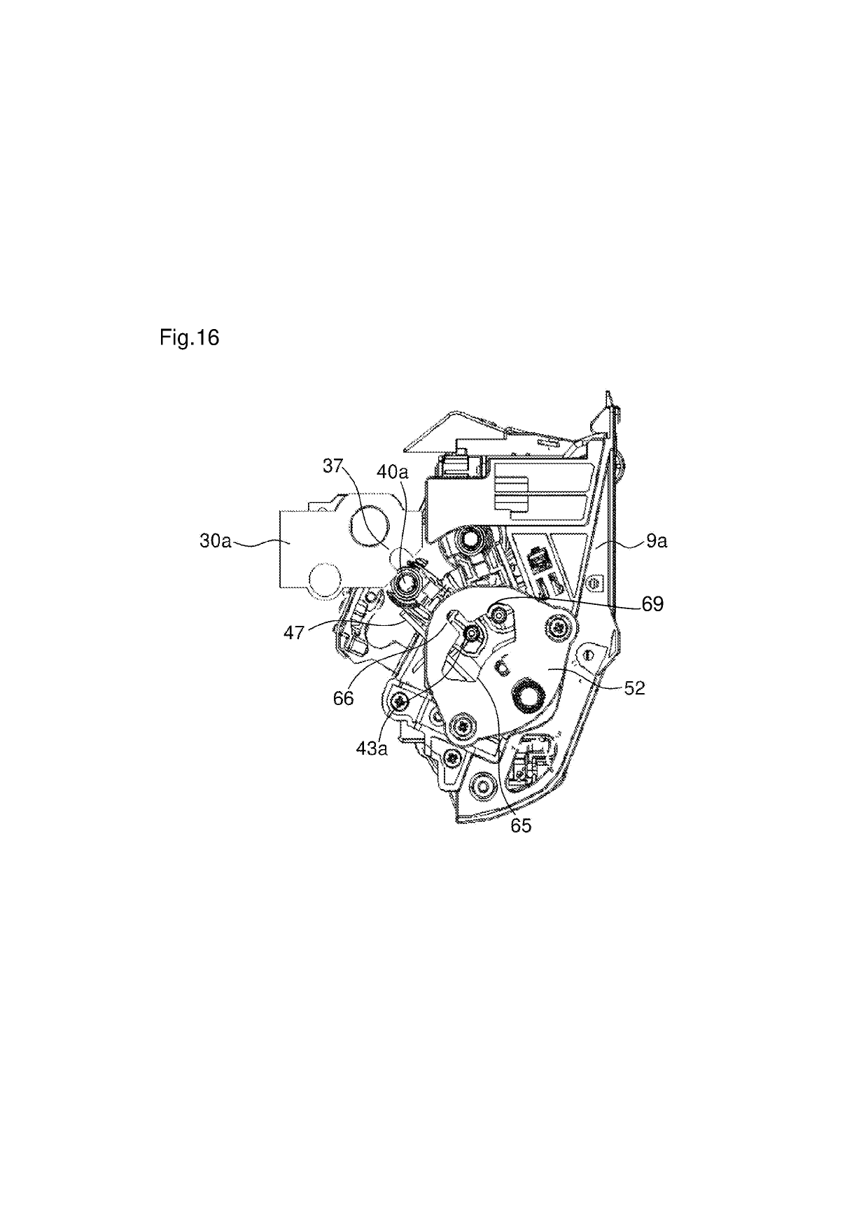

FIG. 16 is a side view showing a state where the first engaging portion 43a of the first bearing member 43 is not engaged with the positioning groove 66 in the fixed cam 52 and the core metal 40a of the first roller 40 is out of the shaft holding portion 37. When the roller to be arranged in the reference position is switched to the first roller 40, as shown in FIG. 16, under the self-weight of the first roller 40 and the roller holder 47, the roller holder 47 may be displaced downward and the core metal 40a may fail to fit in the shaft holding portion 37 of the intermediate transfer unit 30. As a result, the first roller 40 may not be accurately positioned in the reference position, resulting in failure to form the secondary transfer nip portion N.

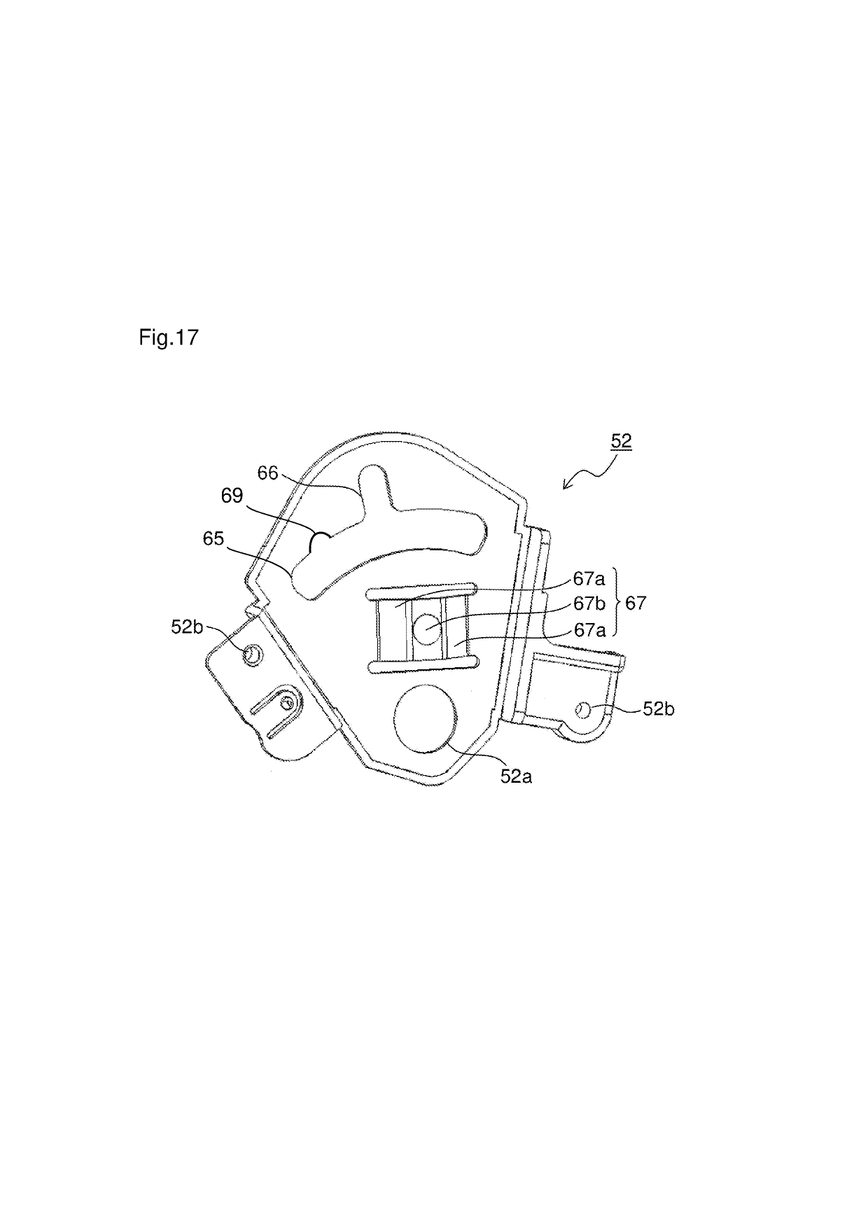

FIG. 17 is a perspective view of the fixed cam 52 used in the secondary transfer unit 9 according to the embodiment, as seen from its side facing the roller holder 47. The fixed cam 52 is formed of a resin material and, as shown in FIG. 17, has a holder positioning projected portion 67 formed in its face facing the roller holder 47.

The holder positioning projected portion 67 is formed between the through hole 52a and the second guide hole 65. The holder positioning projected portion 67 is, in a side view, in the shape of a trapezoid with a pair of sloped faces 67a that inclines along the rotation direction of the roller holder 47 (the left-right direction in FIG. 17) and has a protrusion 67b in a semi-spherical shape between the pair of sloped faces 67a (on a top part of the holder positioning projected portion 67).

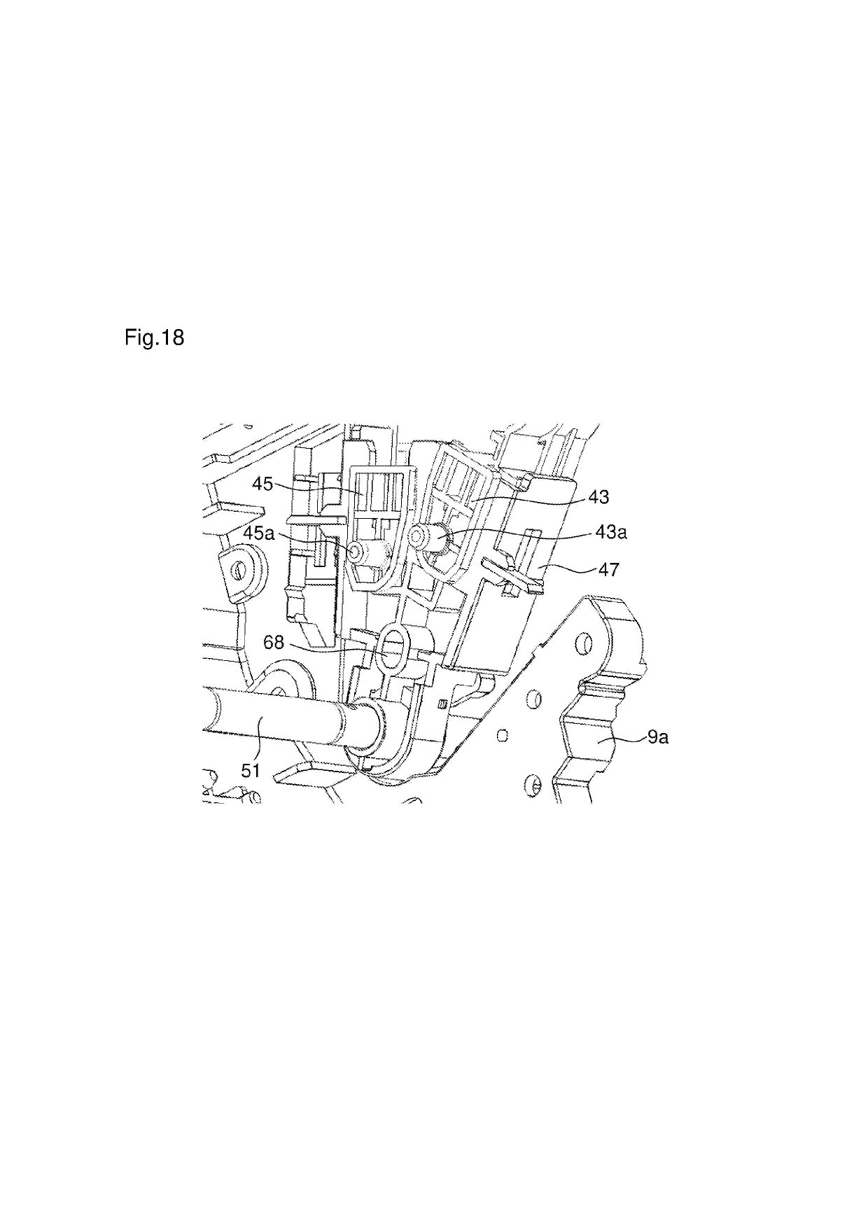

FIG. 18 is a perspective view of the roller holder 47 used in the secondary transfer unit 9 according to the embodiment, as seen from its side facing the fixed cam 52. As shown in FIG. 18, the roller holder 47 has a holder positioning depressed portion 68 formed in its face facing the fixed cam 52. The holder positioning depressed portion 68 is in the shape of an oval that is elongate along the radial direction (top-bottom direction in FIG. 18) perpendicular to the rotation direction of the roller holder 47. The outer diameter of the protrusion 67b (see FIG. 17) on the holder positioning projected portion 67 is slightly larger than the inner diameter of the holder positioning depressed portion 68 along the rotation direction (horizontal direction in FIG. 18) of the roller holder 47.

To arrange the first roller 40 in the reference position, rotating the shaft 51 clockwise from the state in FIG. 14 brings the state in FIG. 9, where the first roller 40 is opposite the drive roller 10. Meanwhile, the roller holder 47 moves across, by sliding over, the sloped face 67a in the holder positioning projected portion 67 formed on the fixed cam 52.

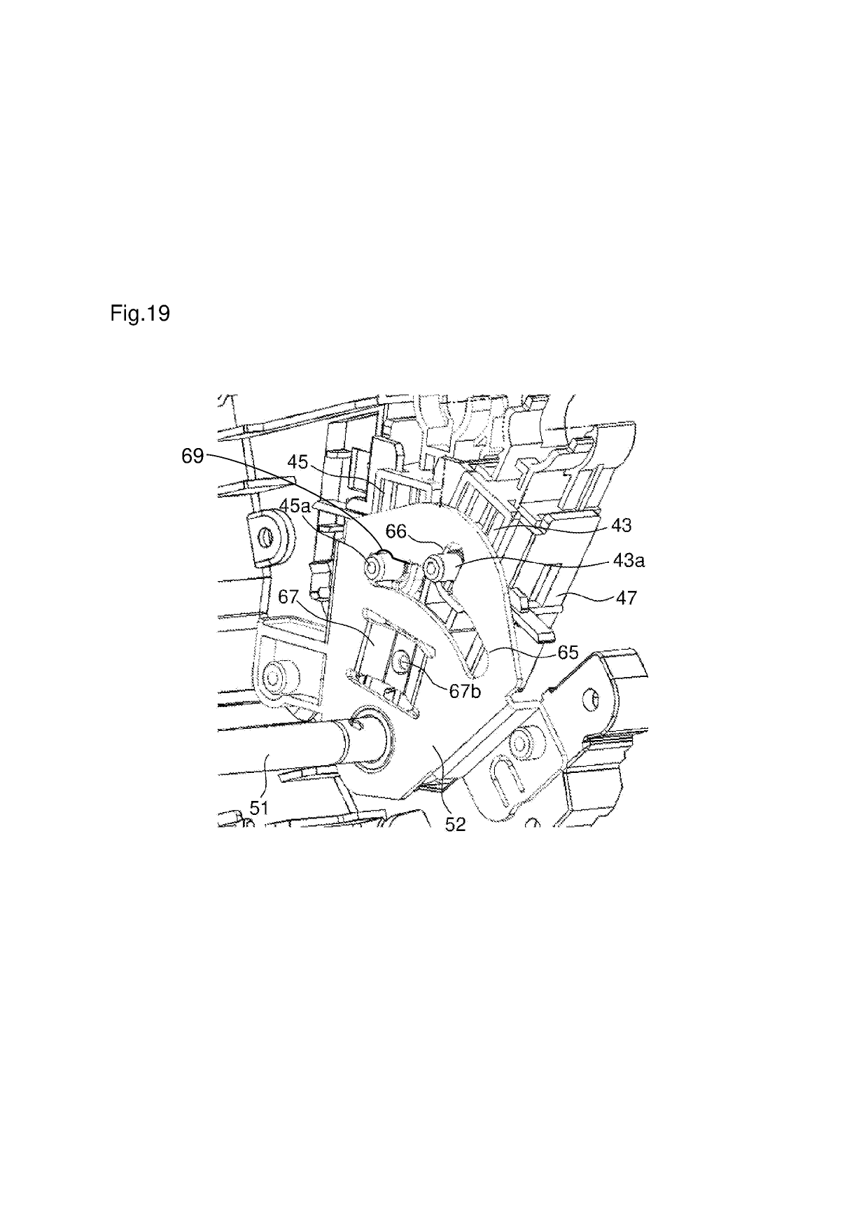

FIG. 19 is a perspective view of the holder positioning projected portion 67 of the fixed cam 52 engaged with the holder positioning depressed portion 68 of the roller holder 47, as seen from inward along the axial direction. When the roller holder 47 moves into the state in FIG. 9; the first engaging portion 43a engages with the positioning groove 66 in the fixed cam 52, the second engaging portion 45a engages with the cam positioning recessed portion 69 of the fixed cam 52, and the protrusion 67b on the holder positioning projected portion 67 engages with the holder positioning depressed portion 68 of the roller holder 47. Here, since the outer diameter of the protrusion 67b is slightly larger than the inner diameter of the holder positioning depressed portion 68, the protrusion 67b is held in a state slightly sunk in the holder positioning depressed portion 68.

That is, the roller holder 47 is positioned at three points with respect to the fixed cam 52, namely at the positioning groove 66, the cam positioning recessed portion 69, and the holder positioning projected portion 67. This positions the first roller 40 accurately at a position opposite the drive roller 10.

According to the embodiment, with a simple configuration using the roller holder 47 and the switching cam 50, it is possible to arrange either the first or second roller 40 or 41 opposite the drive roller 10 and to arrange the first or second roller 40 or 41 arranged opposite the drive roller 10 between the reference position for forming the secondary transfer nip portion N and the separation position away from the intermediate transfer belt 8.

For example, when the sheet S is of a predetermined size (here, A3-sized) or smaller, the first roller 40 having the elastic layer 40b with the smaller length along the axial direction is arranged in the reference position. This prevents, when calibration is performed during image formation with a reference image formed outside the image region on the intermediate transfer belt 8 along the width direction (i.e., in the outside of the first roller 40 along the axial direction), the reference image formed on the intermediate transfer belt 8 from making contact with the first roller 40. This makes it possible to perform calibration during image formation and helps improve image quality without reducing the efficiency of image processing (i.e., productivity).

It is also possible to effectively prevent the staining of the back side of the sheet S resulting from the toner attached to the first roller 40 attaching to the sheet S. Moreover, it is no longer necessary to perform cleaning operation to bring the toner attached to the first roller 40 back onto the intermediate transfer roller 8, and this helps reduce the waiting time for printing.

On the other hand, when the sheet S is of a size (here, 13 inch-sized) larger than the predetermined size, the second roller 41 having the elastic layer 41b with the larger length along the axial direction is arranged in the reference position. This allows reliable secondary transfer of a toner image to the sheet S of a large size in opposite end parts of it along the width direction.

In addition, according to the embodiment, in addition to the switching cam 50, the fixed cam 52 is provided that has the second guide hole 65, the positioning groove 66, and the cam positioning recessed portion 69 formed in it. Thus, when the first roller 40 is arranged at a position opposite the drive roller 10, the first engaging portion 43a of the first bearing member 43 is positioned by engaging with the positioning groove 66 and the second engaging portion 45a of the second bearing member 45 is positioned by engaging with the cam positioning recessed portion 69.

This eliminates the risk of displacement of the first roller 40 along the circumferential direction with the rotation of the switching cam 50 and helps improve the position accuracy with which the first and second rollers 40 and 41 are switched between the pressing state and separation state. It also allows smooth switching of the first roller 40 between the pressing state and separation state and helps reduce the impact, vibration, noise, and the like during switching.

According to the embodiment, the holder positioning projected portion 67 is formed on the face of the fixed cam 52 facing the roller holder 47 and the holder positioning depressed portion 68 is formed in the face of the roller holder 47 facing the fixed cam 52. This eliminates the risk of downward displacement of the roller holder 47 under the self-weight of the first roller 40 when the first roller 40 is arranged in the reference position and helps prevent the failure of the core metal 40a to fit in the shaft holding portion 37 in the intermediate transfer unit 30.

The present disclosure is not limited to the above embodiment and allows for any modifications made within the scope not departing from the spirit of the present disclosure. For example, the shapes, sizes, and the like of the first and second rollers 40 and 41, the roller holder 47, the switching cam 50, the fixed cam 52, and the like constituting the secondary transfer unit 9 are merely examples and they can be modified within a scope consistent with the effect of the present disclosure.

While the above embodiment takes as an example an image forming apparatus 100 employing an intermediate transfer method that includes a secondary transfer unit 9 that secondarily transfers a toner image primarily transferred to the intermediate transfer belt 8 to a sheet S, what is disclosed herein can be implemented in any transfer unit incorporated in an image forming apparatus that, employing a direct transfer method, directly transfers a toner image formed on a photosensitive drum to a sheet.

The present disclosure finds applications in image forming apparatuses including a transfer unit that transfers a toner image formed on an image carrying member to a recording medium. Based on the present disclosure, it is possible to provide a transfer unit that, when one of two transfer rollers selectively kept in pressed contact with an image carrying member is switched to the other, can improve the position accuracy of the roller and the smoothness of its switching, and to provide an image forming apparatus including such a transfer unit.

What is claimed is:

1. A transfer unit including a transfer roller having a core metal and an elastic layer laid on an outer circumferential surface of the core metal, the transfer roller making the elastic layer pressed contact with an image carrying member to form a transfer nip portion, the transfer unit transferring a toner image formed on the image carrying member to a recording medium passing through the transfer nip portion, the transfer unit comprising:
the transfer roller including a first roller and a second roller, the second roller being disposed above the first roller and different from the first roller;
a first bearing member that rotatably supports the first roller;
a second bearing member that rotatably supports the second roller;
a roller holder including a first bearing holding portion and a second bearing holding portion that hold the first and second bearing members respectively such that the first and second bearing members are slidable in directions toward and away from the image carrying member;
a first urging member disposed between the first bearing holding portion and the first bearing member, the first urging member urging the first bearing member in a direction toward the image carrying member;
a second urging member disposed between the second bearing holding portion and the second bearing member, the second urging member urging the second bearing member in a direction toward the image carrying member;
a switching cam having a first guide hole with which a first engaging portion and a second engaging portion formed in the first and second bearing members, respectively, engage;
a driving mechanism that drives the roller holder and the switching cam to rotate;
a unit frame that rotatably supports the roller holder and the switching cam; and
a fixed cam fixed to the unit frame,
wherein
the roller holder is rotated such that either the first or second roller is arranged opposite the image carrying member and
the switching cam is rotated to change an engagement position of the first or second engaging portion with the first guide hole to thereby arrange the first or second roller arranged opposite the image carrying member selectively between a reference position where the first or second roller is kept in pressed contact with the image carrying member to form the transfer nip portion and a separation position where the first or second roller is kept away from the image carrying member, and
the fixed cam includes:
a second guide hole formed so as to overlap the first guide hole, the second guide hole being engaged with the first and second engaging portions;
a positioning groove formed in an outer peripheral part of the second guide hole along a radial direction, the positioning groove being engaged with, when the first roller is arranged opposite the image carrying member, the first engaging portion and, when the second roller is arranged opposite the image carrying member, the second engaging portion; and
a cam positioning recessed portion formed in an outer peripheral part of the second guide hole along the radial direction, the cam positioning recessed portion being engaged with the second engaging portion when the first engaging portion engages with the positioning groove.

2. The transfer unit according to claim 1, wherein,
when the switching cam is rotated;
the first engaging portion moves along a peripheral part of the first guide hole and the first bearing member moves within the positioning groove against an urging force of the first urging member, and simultaneously,
the second engaging portion moves along the peripheral part of the first guide hole and the second bearing member moves within the cam positioning recessed portion against an urging force of the second urging member.

3. The transfer unit according to claim 1, wherein
the fixed cam further includes
a holder positioning projected portion formed on a face of the fixed cam facing the roller holder, the holder positioning projected portion engaging, when the first roller is arranged opposite the image carrying member, a holder positioning depressed portion of the roller holder.

4. An image forming apparatus comprising:
a plurality of image forming portions that form toner images of different colors;
an intermediate transfer belt that moves along the image forming portions, the intermediate transfer belt being endless and functioning as the image carrying member;
a plurality of primary transfer members disposed opposite, across the intermediate transfer belt, photosensitive drums provided in the image forming portions, the plurality of primary transfer members primarily transferring the toner images formed on the photosensitive drums to the intermediate transfer belt; and
the transfer unit according to claim 1 as a secondary transfer unit that secondarily transfers to the recording medium the toner images primarily transferred to the intermediate transfer belt.
